(19) United States
(12) Patent Application Publication
(10) Pub. No.: US 2026/0193057 A1
(43) Pub. Date: Jul. 9, 2026

(54) STATE MONITORING METHOD, STATE MONITORING PROGRAM, RECORDING MEDIUM, AND STATE MONITORING DEVICE FOR ELEVATOR

(71) Applicants: Mitsubishi Electric Building Solutions Corporation, Tokyo (JP); Mitsubishi Electric Corporation, Tokyo (JP)

(72) Inventors: Seiji WATANABE, Tokyo (JP); Ayaka MIZUTANI, Tokyo (JP); Daisuke NAKAZAWA, Tokyo (JP); Kakeru YOKOYAMA, Tokyo (JP); Hideaki SHIMAZU, Tokyo (JP); Yasuhiro KISHIKAWA, Tokyo (JP); Sunao FUJIWARA, Tokyo (JP); Yoshiko ONO, Tokyo (JP)

(73) Assignees: Mitsubishi Electric Building Solutions Corporation, Tokyo (JP); Mitsubishi Electric Corporation, Tokyo (JP)

(21) Appl. No.: 19/131,978

(22) PCT Filed: Nov. 30, 2022
(86) PCT No.: PCT/JP2022/044234

§ 371 Date: May 22, 2025

(51) Int. Cl. B66B 7/12; B66B 5/02

(52) U.S. Cl. CPC B66B 7/1215; B66B 5/02

(57) ABSTRACT

A state monitoring method for an elevator includes a tension calculation step of calculating a tension of each of a plurality of ropes through use of a tension model formed of a plurality of equations of motion. The tension model uses discrete tension data and a plurality of parameters as input data, the discrete tension data including an actually measured value of the tension of the each of the ropes, and uses continuous tension data as output data. In the tension model, a rope free length is set as a displacement amount given to pulley-side end portions of each winding-side portion and each unwinding-side portion, the rope free length assuming a value obtained by subtracting, from a winding amount by a pulley, a rope extension amount within the winding amount.

### TECHNICAL FIELD

This disclosure relates to a state monitoring method, a state monitoring program, a recording medium, and a state monitoring device for an elevator.

### BACKGROUND ART

In a related-art elevator rope elongation detection device, for each of a plurality of elevator ropes, a current tension measured by a rope tension measurement device is compared to a tension at a normal time stored in a storage unit. Then, when a difference between the current tension and the tension at the normal time is equal to or larger than a specified value, a rope slip determination unit determines that a slip has occurred in the relevant elevator rope (see, for example, Patent Literature 1).

In Patent Literature 1, there is disclosed, in the same manner as in Non Patent Literature 1 and Non Patent Literature 2, a formulation relating to the tension of a main rope modeled by one spring. The rope modeling technology as disclosed in those documents is advantageous in that, for example, a computational load is reduced in simulation calculation to achieve higher efficiency as compared to a modeling technology in which a rope is divided into a large number of elements.

However, the rope modeling technology based on one spring is, on the other hand, disadvantageous in that, for example, simulation accuracy of a rope tension is insufficient as described in Non Patent Literature 2. That is, there remains a problem of a difference between an actually measured value and a simulation result regarding the rope tension.

The term “modeling” as used herein means, for example, deriving a model expressed by a mathematical expression, a program, or the like based on an equation of motion for simulating and analyzing a physical behavior, and is also called “modeling.” As a scheme for analyzing a behavior, a simulation analysis using a computer is widely used today, and in addition thereto, a mathematical analysis approach such as examination for a solution of a differential equation using a Laplace transform is also included.

### CITATION LIST

### Patent Literature

[PTL 1] WO 2016/047330 A1

### Non Patent Literature

[NPL 1] Daisuke NAKAZAWA, Seiji WATANABE, and Daiki FUKUI: “Elevator Rope Tension Analysis with Rope Slip Behavior,” The Proceedings of Elevator, Escalator and Amusement Rides Conference, The Japan Society of Mechanical Engineers, (2016), pp. 45-50
[NPL 2] Ayato SHIBAYAMA, Takayoshi KAMADA, Tetsu OGAWA, and Tomohiro SHIKI: “Analysis of Tension Fluctuations of Main Ropes for Elevator due to Variation in Groove Depth of Traction Machine,” The Proceedings of Elevator, Escalator and Amusement Rides Conference, The Japan Society of Mechanical Engineers, (2021)

### SUMMARY OF INVENTION

### Technical Problem

Such a related-art rope modeling technology based on one spring as described above is efficient in calculating a rope tension by simulation, but has been problematic in that simulation accuracy of the rope tension is insufficient.

This disclosure has been made to solve the above-mentioned problem, and has an object to obtain a state monitoring method, a state monitoring program, a recording medium, and a state monitoring device for an elevator which relate to an elevator state monitoring technology capable of estimating a more accurate tension by simple processing.

### Solution to Problem

According to one embodiment of this disclosure, there is provided a state monitoring method for an elevator, including a tension calculation step of respectively modeling, as springs, a winding-side portion and a unwinding side portion of each of a plurality of ropes with respect to a pulley having a plurality of grooves, and calculating a tension of the each of the plurality of ropes through use of a tension model formed of a plurality of equations of motion, the plurality of ropes being wrapped around the pulley and suspending a car and a counterweight, wherein the tension model is configured to: use discrete tension data and a plurality of parameters as input data, the discrete tension data including an actually measured value of the tension of the each of the plurality of ropes in a state in which the car is positioned at a measurement position in a hoistway; and use continuous tension data as output data, the continuous tension data being continuous data on the tension of the each of the plurality of ropes which includes estimated values of the tension of the each of the plurality of ropes in states in which the car is positioned at positions other than the measurement position, and wherein the tension model has a rope free length set as a displacement amount given to pulley-side end portions of each of the winding-side portions and each of the unwinding-side portions, the rope free length assuming a value obtained by subtracting, from a winding amount by the pulley, a rope extension amount within the winding amount.

According to one embodiment of this disclosure, there is provided a state monitoring device for an elevator, including a monitoring device main body configured to respectively model, as springs, a winding-side portion and a unwinding-side portion of each of a plurality of ropes with respect to a pulley having a plurality of grooves, and calculate a tension of the each of the plurality of ropes through use of a tension model formed of a plurality of equations of motion, the plurality of ropes being wrapped around the pulley and suspending a car and counterweight, wherein the tension model is configured to: use discrete tension data and a plurality of parameters as input data, the discrete tension data including an actually measured value of the tension of the each of the plurality of ropes in a state in which the car is positioned at a measurement position in a hoistway; and use continuous tension data as output data, the continuous tension data being continuous data on the tension of the each of the plurality of ropes which includes estimated values of the tension of the each of the plurality of ropes in states in which the car is positioned at positions other than the measurement position, and wherein the tension model has a rope free length set as a displacement amount given to pulley-side end portions of each of the winding-side portions and each of the unwinding-side portions, the rope free length assuming a value obtained by subtracting, from a winding amount by the pulley, a rope extension amount within the winding amount.

### Advantageous Effects of Invention

According to this disclosure, it is possible to estimate a more accurate tension by simple processing.

### BRIEF DESCRIPTION OF DRAWINGS

FIG. 1 is an explanatory view for illustrating an equivalent model of a rope passing over a pulley.

FIG. 2 is an explanatory view for illustrating a model of a one-dimensional coordinate system which replaces the equivalent model of FIG. 1.

FIG. 3 is an explanatory view for illustrating behaviors of a winding-side portion of FIG. 1 modeled by a plurality of different schemes.

FIG. 4 is an explanatory view for illustrating the rope of FIG. 1 divided into the winding-side portion and a unwinding-side portion.

FIG. 5 is an explanatory view for illustrating behaviors of two winding-side portions on which different tensions act in relation to a plurality of different models.

FIG. 6 is a table for showing evaluation results of three models of FIG. 5.

FIG. 7 is an explanatory view for illustrating an example of a model of an elevator.

FIG. 8 is a graph for showing a relationship between tensions of two ropes and a car position in a case in which depths of two grooves are equal to each other.

FIG. 9 is a graph for showing a relationship between the tensions of the two ropes and the car position in a case in which the depths of the two grooves differ from each other by 0.2 mm.

FIG. 10 is a graph for showing a relationship between calculated values of the tensions of the two ropes and the car position in a case in which the depths of the two grooves differ from each other by 0.7 mm in comparison to a plurality of actually measured values.

FIG. 11 is a configuration diagram for schematically illustrating an elevator of a 1:1 roping system in which a plurality of ropes are wrapped around a pulley by a double-wrap system.

FIG. 12 is a graph for showing a relationship between calculated values of the tensions in the elevator of FIG. 11 and the car position in comparison to a plurality of actually measured values.

FIG. 13 is an explanatory diagram for illustrating a relationship between a tension model and input/output data in a first embodiment of this disclosure.

FIG. 14 is a block diagram for illustrating a state monitoring device for an elevator according to the first embodiment.

FIG. 15 is a flow chart for illustrating an operation of a computing unit of FIG. 14.

FIG. 16 is a flow chart for illustrating an operation of a processing part of the tension model of FIG. 15.

FIG. 17 is an explanatory diagram for illustrating a relationship between a tension model and input/output data in a second embodiment of this disclosure.

FIG. 18 is a flow chart for illustrating a part of an operation of a state monitoring device according to the second embodiment.

FIG. 19 is an explanatory diagram for illustrating a relationship between a tension model and input/output data in a third embodiment of this disclosure.

FIG. 20 is a flow chart for illustrating a part of an operation of a state monitoring device according to a fourth embodiment of this disclosure.

FIG. 21 is a flow chart for illustrating a part of an operation of a state monitoring device according to a first modification example of the fourth embodiment.

FIG. 22 is a flow chart for illustrating a part of an operation of a state monitoring device according to a second modification example of the fourth embodiment.

FIG. 23 is a flow chart for illustrating a part of an operation of a state monitoring device according to a fifth embodiment of this disclosure.

FIG. 24 is a flow chart for illustrating a part of an operation of a state monitoring device according to a sixth embodiment of this disclosure.

FIG. 25 is a flow chart for illustrating a part of an operation of a state monitoring device according to a seventh embodiment of this disclosure.

FIG. 26 is a flow chart for illustrating a part of an operation of a state monitoring device according to a modification example of the seventh embodiment.

FIG. 27 is a flow chart for illustrating maintenance timing calculation processing to be performed by a state monitoring device according to an eighth embodiment of this disclosure.

FIG. 28 is a flow chart for illustrating the maintenance timing monitoring processing to be performed by the state monitoring device according to the eighth embodiment.

FIG. 29 is an explanatory diagram for illustrating a relationship between a tension model and input/output data in a modification example of the eighth embodiment.

FIG. 30 is a flow chart for illustrating maintenance timing monitoring processing to be performed in the modification example of the eighth embodiment.

FIG. 31 is a flow chart for illustrating a part of an operation of a state monitoring device according to a tenth embodiment of this disclosure.

FIG. 32 is a configuration diagram for illustrating a first example of a processing circuit for implementing each function of a monitoring device main body in each of the first to tenth embodiments.

FIG. 33 is a configuration diagram for illustrating a second example of the processing circuit for implementing each function of the monitoring device main body in each of the first to tenth embodiments.

### DESCRIPTION OF EMBODIMENTS

Now, embodiments are described with reference to the accompanying drawings.

### First Embodiment

For a model (dynamic model) of a rope wrapped around a pulley, a finite element method (FEM), a multi-body scheme, or the like is conceivable. However, those schemes are high in calculation load and lack general versatility. In view of this, a simple model in which the rope is regarded as one spring is constructed.

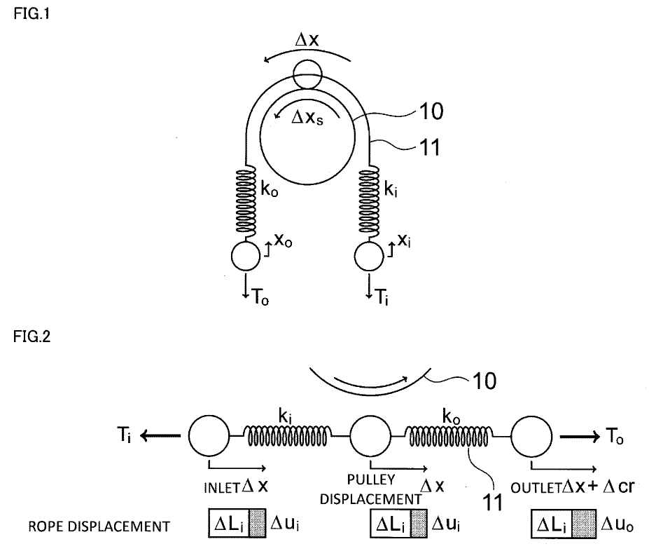

First, consideration is given to the simplest model in which one rope is wrapped around one pulley. FIG. 1 is an explanatory view for illustrating an equivalent model of the rope passing over the pulley. FIG. 2 is an explanatory view for illustrating a model of a one-dimensional coordinate system which replaces the equivalent model of FIG. 1.

In the figure, a rope 11 is wrapped around a pulley 10. The pulley 10 is rotated in a counterclockwise direction in the figure. A moving direction of the rope 11 is determined in accordance with a rotation direction of the pulley 10. In particular, in the model of the rope 11 in the one-dimensional coordinate system illustrated in FIG. 2, a winding-side portion and a unwinding-side portion of the rope 11 move in the same direction in accordance with the rotation direction of the pulley 10.

In the equivalent model of the rope, the rope 11 is formed of three portions, namely, the winding-side portion, the unwinding-side portion, and a portion that moves integrally with the pulley 10 as illustrated in FIG. 1 and FIG. 2. The portion that moves integrally with the pulley 10 is, more precisely, a portion that is positioned on the pulley 10 and is movable integrally with the pulley 10.

In the following figures, variables relating to the winding-side portion of the rope 11 are assigned a subscript “i” in the sense of being an input-side symbol. The winding-side portion is a portion of the rope 11 on an upstream side of the pulley 10 with respect to the moving direction of the rope 11.

Further, variables relating to the unwinding-side portion of the rope 11 are assigned a subscript “o” in the sense of being an output-side symbol. The unwinding-side portion of the rope 11 is a portion of the rope 11 on a downstream side of the pulley 10 with respect to the moving direction of the rope 11.

When the rope 11 is wound by Δx which is a minute winding amount by minute rotation of the pulley 10, the winding amount Δx is expressed by a sum of a rope free length ΔLi and a rope extension amount Δui. The rope free length ΔLi is a length in a state in which no tension acts.

That is, the winding amount Δx corresponds to a rope displacement amount in a state in which tensions act, and assumes a value obtained by adding a rope extension amount due to the tensions to the rope free length ΔLi which is the rope displacement amount in a state in which no tension acts. As illustrated in FIG. 2, in regard to the winding-side portion, the unwinding-side portion, and the portion that moves integrally with the pulley, the rope displacement amounts in a state in which no tension acts are each equal to the same rope free length ΔLi.

$$Δ x = Δ Li + Δ ui \qquad ( 1.1 )$$

The rope extension amount Δui of the winding-side portion is obtained from a tension Ti of the winding-side portion. Meanwhile, the tension of the unwinding-side portion is To, and hence a rope extension amount Δuo of the unwinding-side portion is different from the rope extension amount Δui of the winding-side portion.

Therefore, a creep amount Δcr which is a minute slip amount of the rope 11 on the pulley 10 is a rope extension amount difference Δuo−Δui with respect to the rope free length ΔLi.

$$Δ x + Δ cr = ( Δ Li + Δ ui ) + ( Δ uo - Δ ui ) = Δ Li + Δ uo \qquad ( 1.2 )$$

It has been experimentally confirmed through use of an actual machine that a lower end of the winding-side portion and a lower end of the unwinding-side portion exhibit the following behaviors in relation to handling of the rope extension amounts. In FIG. 1, xi represents a displacement of the lower end of the winding-side portion. Further, xo represents a displacement of the lower end of the unwinding-side portion.

With regard to the behaviors described here, that is, in relation to the handling of the rope extension amounts, attention has been successfully paid to the behaviors of the lower end of the winding-side portion and the lower end of the unwinding-side portion, and this fact is a key point that has led to the current proposal of a model of a rope and an elevator having excellent characteristics.
The lower end of the winding-side portion rises by the same amount as the winding amount Δx of the rope 11 on the pulley 10.
The lower end of the unwinding-side portion lowers by an amount different from the winding amount Δx on the pulley 10 in general.

FIG. 3 is an explanatory view for illustrating behaviors of the winding-side portion of the rope 11 of FIG. 1 modeled by a plurality of different schemes. In particular, FIG. 3 mentioned here and FIG. 5 mentioned later are used as explanatory diagrams effective for illustrating that part (c) which is a model of the rope 11 currently proposed as a scheme in a first embodiment of this disclosure has excellent characteristics.

In FIG. 3, part (a) is an illustration of a multi-body model. In the multi-body model, the winding-side portion is divided into a plurality of minute sections. Further, in the multi-body model, when an upper end of the winding-side portion is wound by Δx, the lower end of the winding-side portion rises by Δχ.

In this case, the minute winding amount Δx is separated into the rope free length ΔLi and the rope extension amount Δui. Assuming that a spring constant determined by a length of the winding-side portion before winding is ki, the length of the winding-side portion is reduced by Δx after winding, and hence the spring constant is changed to k′i after winding. At this time, k′i>ki. In the following description, the spring constant may be referred to also as “rope rigidity” in some cases.

In FIG. 3, part (a′) represents the winding-side portion of the rope 11 modeled as one spring. In this model, when the upper end of the winding-side portion is wound by Δx, the lower end of the winding-side portion also rises by Δx. Further, in this model, the spring constant remains ki. However, in an actual case, the spring constant has changed to k′i.

In FIG. 3, part (b) represents a model in which the spring constant in the model of part (a′) is changed to k′i, and the position of the upper end of the winding-side portion is the same as that in the model of part (a′). The lower end of the winding-side portion has risen by Aui relative to the model of part (a′). This is an effect of reduction in amount of deflection of the winding-side portion due to an increase in rope rigidity from ki to k′i.

The behavior of the lower end of the winding-side portion is actually the same as that in the model of part (a). However, in the model of part (b), the behavior of the lower end of the winding-side portion is different from the actual behavior successfully confirmed by the above-mentioned actual machine.

In FIG. 3, part (c) represents the model of the rope 11 used in the first embodiment. In this model, the position of the upper end of the winding-side portion is lower than those in the model of part (a), the model of part (a′), and the model of part (b). In the model of part (c), the position of the lower end of the winding-side portion is the same as those in the model of part (a) and the model of part (a′).

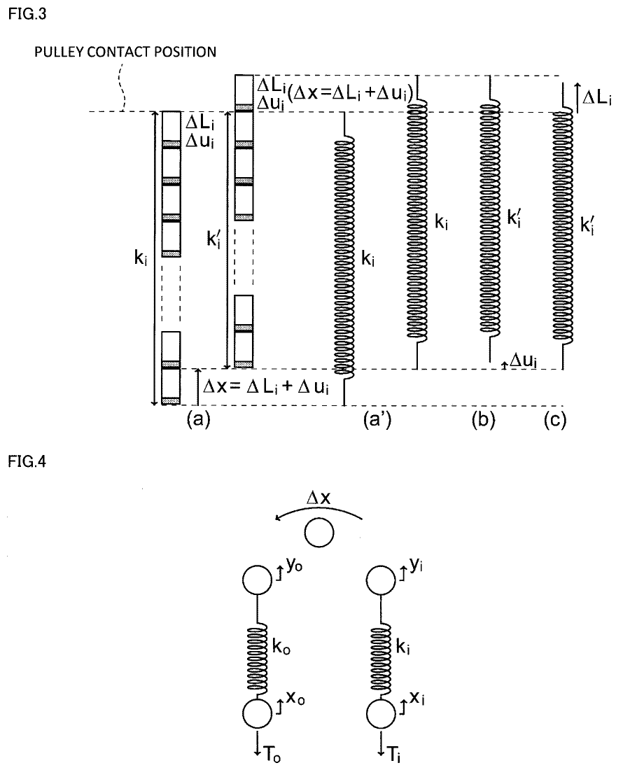

FIG. 4 is an explanatory view for illustrating the equivalent model of FIG. 1 divided into the winding-side portion and the unwinding-side portion. In FIG. 4, the winding-side portion and the unwinding-side portion are each modeled as independent springs. Accordingly, it is possible to consider a force balance condition with respect to a spring force, that is, tension, determined by a displacement difference between both ends of each spring.

In FIG. 4, yi represents a displacement of the upper end of the winding-side portion. Further, yo represents a displacement of an upper end of the unwinding-side portion. A relational expression for the winding-side portion under a static state, that is, before winding, is given by the following expression.

$$Ti = ki ( yi - xi ) = ( EA / Li ) ( 0 - {x}^{′} i ) \qquad ( 1.3 )$$

In the expression, ki represents the rope rigidity of the winding-side portion, yi represents the displacement of the upper end of the winding-side portion, xi represents the displacement of the lower end of the winding-side portion, Li represents the length of the winding-side portion, E represents a Young's modulus of the rope 11, and A represents a cross-sectional area of a cross section perpendicular to a length direction of the rope 11.

Further, x′i represents an initial extension amount of the lower end of the winding-side portion, and assumes a negative value. The coordinate system for this case is defined as having a positive displacement in an upward direction. The rope rigidity ki of the winding-side portion is a function of the Young's modulus E, the cross-sectional area A, and the length Li of the winding-side portion.

The winding-side portion is wound on the pulley 10 while being subjected to the tension Ti, and hence the following relational expression is obtained.

$$Ti = ( EA / Δ Li ) Δ ui \qquad ( 1.4 )$$

When the winding-side portion is minutely wound by Δx on the pulley 10, the lower end of the winding-side portion rises by Δx as illustrated in FIG. 2 and FIG. 3 regardless of the rope rigidity. Therefore, a force balance after the winding by Δx is given by the following expression.

$$Ti = ( EA / ( Li - Δ Li ) ) ( yi - xi ) = ( EA / ( Li - Δ Li ) ) \{ yi - ( {x}^{′} i + Δ x ) \} \qquad ( 1.5 )$$

The tension Ti of the winding-side portion is calculated from a displacement difference yi-xi between the upper end and the lower end of the winding-side portion. From this expression, a relational expression to be satisfied by the displacement yi of the upper end of the winding-side portion is also obtained.

$$yi = ( Ti / EA ) ( Li - Δ Li ) + {x}^{′} i + Δ x \qquad ( 1.6 )$$

The above-mentioned expression is rearranged through use of Expression (1.1), Expression (1.3), and Expression (1.4) to obtain the following expression.

$$\begin{matrix}yi = ( Ti / EA ) ( Li - Δ Li ) - ( Ti / EA ) Li + Δ Li + Δ ui \\ = - ( Ti / EA ) Δ Li + Δ Li + Δ ui \\ = - Δ ui + Δ Li + Δ ui = Δ Li\end{matrix} \qquad ( 1.7 )$$

Therefore, the displacement yi of the upper end of the winding-side portion at a time of minute winding is required to be set to be equal to the rope free length ΔLi within the winding amount Δx instead of being set to be equal to the winding amount Δx, namely, ΔLi+Δui. Accordingly, the displacement xi of the lower end of the winding-side portion becomes the winding amount Δx, and a result corresponding to part (a) of FIG. 3 is obtained.

In this manner, in part (c) of FIG. 3 which is the scheme in the first embodiment, the behavior of the lower end of the winding-side portion is correctly evaluated.

FIG. 5 is an explanatory view for illustrating behaviors of two winding-side portions on which different tensions act in relation to a plurality of different models. In FIG. 5, part (a), part (b), and part (c) are models corresponding to those of part (a), part (b), and part (c) of FIG. 3, respectively.

In the model of part (a), even with tensions Ti1 and Ti2 that are different from each other, the lower ends of the two winding-side portions are displaced upward by the same distance Δx as the winding amount Δx.

In contrast, in the model of part (b), the displacement of the upper ends of the two winding-side portions is Δx, while the lower end of one winding-side portion is displaced upward by Δx+Δui1, and the lower end of the other winding-side portion is displaced upward by Δx+Δui2.

In an actual elevator, the lower ends of the two winding-side portions are connected to a car or a counterweight, and the displacement amounts are equal to each other. Therefore, in regard to the winding-side portion on which the tension Ti1 smaller than the tension Ti2 acts, the lower end is excessively pulled up, and loosening occurs to reduce the tension. Meanwhile, in regard to the winding-side portion on which the tension Ti2 acts, the lower end is pulled down to increase the tension.

In this manner, in the model of part (b), when the same winding amount Δx is given to the two winding-side portions having different tensions, a restraining force for aligning the lower end positions acts on a deviation of the lower end, thereby changing the tension.

In contrast, in the model of part (c), pull-up amounts of the upper ends of the two winding-side portions are not uniformly Δx but are equal to rope free lengths ΔLi1 and ΔLi2 on the pulley 10 which correspond to the tension, thereby being different from each other. Through correction of those pull-up amounts, the displacement amounts of the lower ends of the two winding-side portions are both Δx, and match those of the model of part (a).

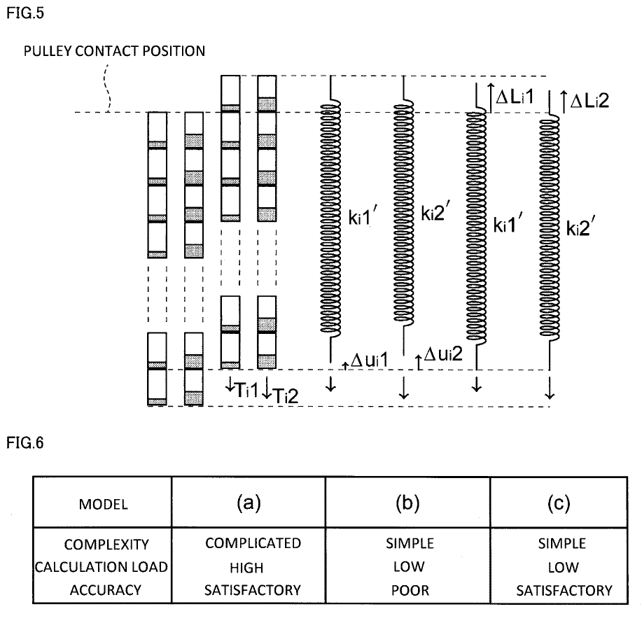

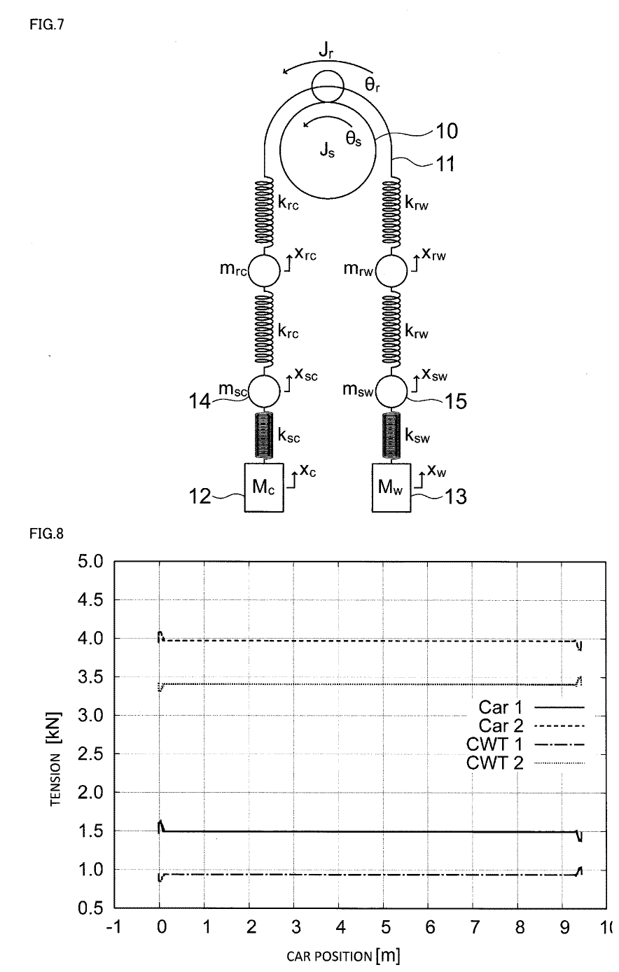

FIG. 6 is a table for showing evaluation results of the three models of FIG. 5. While the multi-body scheme of part (a) can accurately model winding behaviors, it is required to divide the rope 11 into a large number of portions, resulting in complication of the model and causing an increase in calculation time.

In contrast, in the schemes of part (b) and part (c) in which the rope 11 is modeled as springs, each model is simple and the calculation load is low. However, in the model of part (b), the tension at the winding-side portion has not been correctly evaluated. Meanwhile, in the model of part (c) currently proposed as the scheme in the first embodiment, the tension evaluation at the winding-side portion is accurate.

The model of part (c) is a simple model, and hence the calculation load is low, thereby enabling a tension fluctuation at each car position for all the ropes to be easily calculated in real time even in a portable maintenance work personal computer (PC) or a control panel (CP) which have memory constraints.

Therefore, through use of tension measurement data at limited car positions at a maintenance site, the tensions of all the ropes at each car position can be grasped, thereby being able to achieve reduction in maintenance time.

Next, the unwinding-side portion is described. From FIG. 4, a relational expression for the unwinding-side portion under the static state is as follows.

$$To = ko ( yo - xo ) = ( EA / lo ) ( 0 - {x}^{′} o ) \qquad ( 1.8 )$$

In the expression, ko represents the rope rigidity of the unwinding-side portion, yo represents the displacement of the upper end of the unwinding-side portion, xo represents the displacement of the lower end of the unwinding-side portion, Lo represents the length of the unwinding-side portion, E represents the Young's modulus of the rope 11, and A represents the cross-sectional area of the cross section perpendicular to the length direction of the rope 11.

Further, x′o represents an initial extension amount of the lower end of the unwinding-side portion, and assumes a negative value. The rope rigidity ko of the unwinding-side portion is a function of the Young's modulus E, the cross-sectional area A, and the length Lo of the unwinding-side portion.

When the winding-side portion is wound by Δx, the unwinding-side portion becomes longer by the rope free length ΔLi on the pulley 10. Further, the rope free length ΔLi of the unwinding-side portion is extended by Δuo due to the tension To of the unwinding-side portion.

$$To = ( EA / Δ Li ) Δ uo \qquad ( 1.9 )$$

Therefore, when the rope 11 is minutely wound by Δx on the pulley 10, the lower end of the unwinding-side portion is displaced downward by ΔLi+Δuo. A force balance at the unwinding-side portion after the winding by Δx is given by the following expression.

$$\begin{matrix}To = ( EA / ( Lo + Δ Li ) ) ( yo - xo ) \\ = ( EA / ( Lo + Δ Li ) ) \{ yo - ( {x}^{′} o - Δ Li - Δ uo ) \}\end{matrix} \qquad ( 1.1 )$$

The tension To of the unwinding-side portion is calculated from a displacement difference yo−xo between the upper end and the lower end of the unwinding-side portion. From this expression, a relational expression to be satisfied by the displacement yo of the upper end of the unwinding-side portion is also obtained.

$$yo = ( To / EA ) ( Lo + Δ Li ) + {x}^{′} o - Δ Li - Δ uo \qquad ( 1.11 )$$

The above-mentioned expression is rearranged through use of Expression (1.11), Expression (1.8), and Expression (1.9).

$$\begin{matrix}yo = ( To / EA ) ( Lo - Δ Li ) - ( To / EA ) Lo + Δ Li + Δ uo \\ = ( To / EA ) Δ Li + Δ Li + Δ uo \\ = Δ uo - Δ Li + Δ uo = - Δ Li\end{matrix} \qquad ( 1.12 )$$

From this expression, the displacement yo of the upper end given to the rope rigidity ko of the unwinding-side portion is required to be set to be a rope free length −ΔLi within the winding amount instead of being set to be a winding amount −Δx. As a result, the displacement xo of the lower end of the unwinding-side portion becomes an unwinding amount ΔLi+Δuo.

The displacement xo of the lower end of the unwinding-side portion is ΔLi+Δuo, which is different from the displacement Δx=ΔLi+Δui of the lower end of the winding-side portion. A difference therebetween is the creep amount Δcr of the rope 11 on the pulley 10.

$$Δ cr = Δ uo - Δ ui = ( Δ Li / EA ) ( To - Ti ) \qquad ( 1.13 )$$

Examination has been made so far for a formulation in a case in which, as illustrated in FIG. 1, the pulley 10 is rotated in the counterclockwise direction of FIG. 1. In contrast, when consideration is given to the relational expression in a case in which the pulley 10 is rotated in a clockwise direction illustrated in FIG. 1, it is possible to use the counterclockwise relational expression as it is by defining the winding amount Δx as a negative value. However, the tension of the winding-side portion becomes To of FIG. 1, and hence it is required to replace Ti in Expression (1.4) by To of FIG. 1.

Further, in FIG. 1, a configuration in which the rope 11 is wrapped around an upper portion of the pulley 10 and the rope 11 is pulled downward is illustrated. However, the derived relational expression is unchanged even in a configuration in which the rope 11 is wrapped around a lower portion of the pulley 10 and the rope 11 is pulled upward.

A winding model of the rope 11 onto the pulley 10 can be summarized based on the above-mentioned results as follows.
The winding amount Δx is set to have a sign corresponding to the rotation direction with a counterclockwise rope displacement and a clockwise rope displacement on the pulley 10 being set to be positive and negative, respectively.
The rope rigidity ki of the winding-side portion is defined as a value obtained by dividing the product of the cross-sectional area A and the Young's modulus E of the rope 11 by the length Li of the winding-side portion.
The rope rigidity ko of the unwinding-side portion is defined as a value obtained by dividing the product of the cross-sectional area A and the Young's modulus E of the rope 11 by the length Lo of the unwinding-side portion.
The lengths Li and Lo at a time of determining the rope rigidities ki and ko are set to the rope free length obtained when no tension acts on the rope 11.
   The tension Ti of the winding-side portion is defined as a value obtained by multiplying the rope rigidity ki by the displacement difference yi-xi of the upper and lower ends.
The tension To of the unwinding-side portion is defined as a value obtained by multiplying the rope rigidity ko by the displacement difference yo−xo of the upper and lower ends.
   A displacement of an end portion of the winding-side portion on the pulley 10 side is defined as a value obtained by excluding the rope extension amount Δui of the winding-side portion from the minute winding amount Δx of the rope 11 on the pulley 10, and corresponds to the rope free length ΔLi with respect to the winding amount Δx.
A displacement of an end portion of the unwinding-side portion on the pulley 10 side is defined as a value obtained by excluding the rope extension amount Δui of the winding-side portion from the minute winding amount Δx of the rope 11 on the pulley 10, and corresponds to the rope free length ΔLi with respect to the winding amount Δx.
The above-mentioned rope extension amount on the pulley 10 is calculated from the tension Ti of the winding-side portion.

Next, FIG. 7 is an explanatory view for illustrating an example of a model of the elevator. In FIG. 7, a model in which the number of ropes is 1 in a 1:1 roping system is illustrated as the simplest model.

In this case, the rope model of part (c) described above is further described by being incorporated into an elevator model. That is, in this case, as the elevator model, an elevator in which a car 12 and a counterweight 13 are each suspended by the rope 11 in a well bucket manner through use of the pulley 10 which is a traction sheave, and the rope 11 is wound on or unwound from the pulley 10 to raise or lower the car 12 and the counterweight 13 is assumed.

Respective elements of the elevator are modeled as a spring and mass point system. The rope 11 is modeled as mass point element on the pulley 10 and as spring elements on the winding portion side and the unwinding portion side.

In FIG. 7, Js represents a moment of inertia of the pulley 10, and Jr represents a moment of inertia of the rope 11 on the pulley 10. Jr is the moment of inertia due to a mass of the above-mentioned rope portion moving integrally with the pulley 10. Mc represents a mass of the car 12, Mw represents a mass of the counterweight 13, msc represents a mass of a car-side shackle 14, and msw represents a mass of a counterweight-side shackle 15. Those are parameters relating to inertial elements.

Further, mrc represents a mass of a car-side portion of the rope 11, and mrw represents a mass of a counterweight-side portion of the rope 11. The car-side portion is a portion of the rope 11 which is positioned on the car 12 side relative to the pulley 10. The counterweight-side portion is a portion of the rope 11 which is positioned on the counterweight 13 side relative to the pulley 10. Those are also parameters relating to inertial elements in the same manner as described above.

Further, ksc represents a rigidity of the car-side shackle 14, ksw represents a rigidity of the counterweight-side shackle 15, krc represents a rigidity of the car-side portion of the rope 11, and krw represents a rigidity of the counterweight-side portion of the rope 11. Those are parameters relating to rigidity elements.

Further, θs represents a rotation angle of the pulley 10, and θr represents a rotation angle of the rope 11 on the pulley 10. Further, xc represents a displacement of the car 12, xw represents a displacement of the counterweight 13, XSC represents a displacement of the car-side shackle 14, XSW represents a displacement of the counterweight-side shackle 15, xrc represents a displacement of the car-side portion of the rope 11, and xrw represents a displacement of the counterweight-side portion of the rope 11.

Equations of motion each expressed by a differential equation that does not take a damping term due to a damping element into consideration are as follows. In this case, d\hat{ }2/dt\hat{ }2 is used as an operator indicating a second-order differential operation with respect to a time “t”.

$$Mc ( d \hat{} 2 / dt \hat{} 2 ) xc - ksc ( xsc - xc ) = - Mc g \qquad ( 1.14 )$$

$$Mw ( d \hat{} 2 / dt \hat{} 2 ) xw - ksw ( xsw - xw ) = - Mw g \qquad ( 1.15 )$$

$$msc ( d \hat{} 2 / dt \hat{} 2 ) xsc + ksc ( xcs - xc ) - krc ( xrc - xsc ) = - msc g \qquad ( 1.16 )$$

$$msw ( d \hat{} 2 / dt \hat{} 2 ) xsw + ksw ( xsw - xw ) - krw ( xrw - xsw ) = - msw g \qquad ( 1.17 )$$

$$mrc ( d \hat{} 2 / dt \hat{} 2 ) xrc + krc ( xrc - xsc ) - krc ( - R θ r - xrc ) = - mrc g \qquad ( 1.18 )$$

$$mrw ( d \hat{} 2 / dt \hat{} 2 ) xrw + krw ( xrw - xsw ) - krw ( - R θ r - xrw ) = - mrw g \qquad ( 1.19 )$$

$$Js ( d \hat{} 2 / dt \hat{} 2 ) θ s = τ - λ \qquad ( 1.2 )$$

$$Jr ( d \hat{} 2 / dt \hat{} 2 ) θ r - krcR ( - R θ r - xrc ) + krwR ( R θ r - xrw ) = λ \qquad ( 1.21 )$$

In the expressions, R represents a radius of the pulley 10, and “g” represents a gravitational acceleration. Further, τ represents a driving torque applied to the pulley 10, and λ represents a constraint torque acting between the pulley 10 and the rope 11.

On the pulley 10, the pulley 10 and the rope 11 integrally move within a range of a maximum traction ratio Γ. The maximum traction ratio Γ is given as a function of a friction coefficient between the pulley 10 and the rope 11 and a wrap angle of the rope 11 with respect to the pulley 10.

At this time, a constraint conditional expression and a condition to be satisfied by a ratio of the tension To of the unwinding-side portion of the rope 11 to the tension Ti of the winding-side portion of the rope 11 are given by the following expressions. In this case, d/dt is used as an operator indicating a first-order differential operation with respect to the time “t”.

$$( 1 / Γ ) < ( To / Ti ) < Γ \qquad ( 1.22 )$$

$$( d / dt ) θ s - ( d / dt ) θ r = 0 \qquad ( 1.23 )$$

The constraint torque λ acts on the pulley 10 and the rope 11 as a force satisfying the above-mentioned expressions. Meanwhile, when the tension ratio To/Ti exceeds the maximum traction ratio Γ, the rope 11 slips against the pulley 10 while a frictional force acts thereon, thereby causing a difference between a rotation speed of the pulley 10 and a rotation speed of the rope 11.

$$( d / dt ) θ s - ( d / dt ) θ r \neq 0 \qquad ( 1.24 )$$

Now, behaviors exhibited when the car 12 is lowered, that is, when the pulley 10 is rotated in the counterclockwise direction of FIG. 7 are described. Consideration is given to a balanced state at a time t+Δt after a lapse of a minute time Δt based on a balanced state at the time “t”. When the car 12 is lowered for the minute time Δt, the winding amount Δx on the pulley 10 is given by the following expression.

$$Δ x = R Δ θ r = Δ L + Δ u \qquad ( 1.25 )$$

In the expression, ΔL represents a rope free length with respect to the minute winding amount Δx which is exhibited when the car 12 is lowered, that is, a rope length in a state in which no tension acts. Further, Au represents a rope extension amount with respect to the minute winding amount Δx which is exhibited when the car 12 is lowered.

A plurality of grooves are formed in an outer periphery of the pulley 10. Corresponding ropes 11 are inserted into the respective grooves. Each groove is worn over time by the rope 11. The radius R is a radius of the pulley 10 with respect to each groove, and hence when wear amounts of the plurality of grooves are different from each other, the radius R minutely differs depending on the groove.

Such a difference in radius R causes a difference in winding amount, thereby causing a tension difference between a plurality of ropes 11.

Assuming that the tension acting on the counterweight-side portion of the rope 11 is Tw, Au satisfies the following expression.

$$Tw = ( EA / Δ L ) Δ u \to Δ u = ( Tw / EA ) Δ L \qquad ( 1.26 )$$

Therefore, the rope free length ΔL can be obtained from the minute winding amount Δx.

$$Δ x = ( 1 + ( Tw / EA ) ) Δ L \to Δ L = Δ x / ( 1 + ( Tw / EA ) )$$

From this expression, a length Lc of the car-side portion of the rope 11 and a length Lw of the counterweight-side portion of the rope 11 are respectively given by the following expressions.

$$\begin{matrix}Lo ( t + Δ t ) = Lc ( t + Δ t ) = Lc ( t ) + Δ L , and \\ Li ( t + Δ t ) = Lw ( t + Δ t ) = Lw ( t ) - Δ L\end{matrix} \qquad ( 1.28 )$$

The winding amount at the time t+Δt and the corresponding rope free length and rope extension amount are respectively given by the following expressions.

$$\begin{matrix}x ( t + Δ t ) = x ( t ) + Δ x , \\ L ( t + Δ t ) = L ( t ) + Δ L , and \\ u ( t + Δ t ) = u ( t ) + Δ u\end{matrix} \qquad ( 1.29 )$$

The amount x(t+Δt)=Rθr(t+Δt) wound on the sheave 10 includes the rope extension amount. However, in order to calculate the tension generated in the winding-side portion of the rope 11 and the tension generated in the unwinding-side portion of the rope 11, it is required to set a rope free length L instead of using Rθr as the winding amount as it is.

The rope free length L can be obtained by the following expression.

$$\begin{matrix}x ( t + Δ t ) = R θ r ( t + Δ t ) \\ = L ( t + Δ t ) + u ( t + Δ t ) \to L = R θ r - u\end{matrix} \qquad ( 1.3 )$$

Therefore, the tension Ti generated in the winding-side portion of the rope 11 is given by the following expression.

$$\begin{matrix}Ti = Tw = ki ( L - xrw ) \\ = krw ( L - xrw ) = krw ( R θ r - u - xrw )\end{matrix} \qquad ( 1.31 )$$

Further, the tension To generated in the unwinding-side portion of the rope 11 is given by the following expression.

$$\begin{matrix}To = k o ( - L - x r c ) \\ = krc ( - L - xrc ) = krc ( - R θ r + u - xrc )\end{matrix} \qquad ( 1.32 )$$

From those expressions, a part representing the winding amount in the equations of motion (1.18), (1.19), and (1.21) is modified as given by the following expression.

$$R θ r \to R θ r - u \qquad ( 1.33 )$$

Next, behaviors exhibited when the car 12 is raised, that is, when the pulley 10 is rotated in the clockwise direction of FIG. 7 are described. When the car 12 is raised for the minute time Δt, the winding amount Δx on the pulley 10 is given by the following expression. The counterclockwise direction of FIG. 7 is set to be positive, and hence when the pulley 10 is rotated in the clockwise direction of FIG. 7, the winding amount Δx assumes a negative value.

$$Δ x = R θ r = Δ L + Δ u \qquad ( 1.34 )$$

In the expression, Au represents the rope extension amount with respect to the minute winding amount Δx which is exhibited when the car 12 is raised, and assumes a negative value.

Assuming that the tension acting on the car-side portion of the rope 11 is Tc, Au satisfies the following expression.

$$Tc = ( EA / Δ L ) Δ u \to Δ u = ( Tc / EA ) Δ L \qquad ( 1.35 )$$

Therefore, the rope free length ΔL can be obtained from the minute winding amount Δx.

$$Δ x = ( 1 + ( Tc / EA ) ) Δ L \to Δ L = Δ x / ( 1 + ( Tc / EA ) ) \qquad ( 1.36 )$$

From this expression, the length Lc of the car-side portion of the rope 11 and the length Lw of the counterweight-side portion of the rope 11 are respectively given by the following expressions.

$$\begin{matrix}Li ( t + Δ t ) = Lc ( t + Δ t ) = Lc ( t ) + Δ L , and \\ Lo ( t + Δ t ) = Lw ( t + Δ t ) = Lw ( t ) - Δ L\end{matrix} \qquad ( 1.37 )$$

In this case, the free length ΔL assumes a negative value, and hence the rope length of the car-side portion decreases, while the rope length of the counterweight-side portion increases.

The rope free length L exhibited when the car 12 is raised can be obtained by the following expression.

$$\begin{matrix}x ( t + Δ t ) = R θ r ( t + Δ t ) \\ = L ( t + Δ t ) + u ( t + Δ t ) \to L = R θ\end{matrix} \qquad ( 1.38 )$$

Therefore, the tension Ti generated in the winding-side portion of the rope 11 is given by the following expression.

$$\begin{matrix}Ti = Tc = ki ( - L - xrc ) \\ = krc ( - L - xrc ) = krc ( - R θ r + u - xrc )\end{matrix} \qquad ( 1.39 )$$

Further, the tension To generated in the unwinding-side portion of the rope 11 is given by the following expression.

$$\begin{matrix}To = ko ( L - xrw ) \\ = krw ( L - xrw ) = krw ( R θ r - u - xrw )\end{matrix} \qquad ( 1.4 )$$

From those expressions, a part representing the winding amount in the equations of motion (1.18), (1.19), and (1.21) is modified as given by the following expression.

$$R θ r \to R θ r - u \qquad ( 1.41 )$$

From the above-mentioned results, a tension model serving as a generalized rope winding model can be defined as follows. In such a manner, the tension model is formed of a plurality of equations of motion. Herein and in the appended claims, an analysis model for rope tension is referred to as “tension model” in a simplified manner.

Regardless of a traveling direction of the car 12, the rope length Lc on the car 12 side and the rope length Lw on the counterweight 13 side are respectively obtained by the following expressions. That is, the length of the winding-side portion and the length of the unwinding-side portion are calculated from the rope free length ΔL.

$$Lc ( t + Δ t ) = Lc ( t ) + Δ L , and Lw ( t + Δ t ) = Lw ( t ) - Δ L \qquad ( 1.42 )$$

In this case, ΔL satisfies the following expressions.

At the time of lowering a car: ΔL=Expression (1.27), and at the time of raising the car: ΔL=Expression (1.36) (1.43)

A part representing the winding amount in the equations of motion (1.18), (1.19), and (1.21) is modified as given by the following expression.

$$R θ r \to R θ r - u \qquad ( 1.44 )$$

As indicated in Expression (1.27) and Expression (1.36), the rope free length ΔL is a function of the winding amount Δx and the tension Ti of the winding-side portion.

In this case, a relational expression of a correction amount “u” in a minute time is given by the following expression.

$$u ( t + Δ t ) = u ( t ) + Δ u \qquad ( 1.45 )$$

At the time of lowering the car: Δu=Expression (1.26), and at the time of raising the car: Δu=Expression (1.35) (1.46)

As indicated in Expression (1.26) and Expression (1.35), the rope extension amount Δu assumes a value proportional to the rope free length ΔL and the tension Ti of the winding-side portion.

The above-mentioned relational expression is established in the same manner even when one or more pulleys are present in addition to the pulley 10 which is a traction sheave, and is established in the same manner regardless of the number of ropes 11.

Next, as an example, calculation results in a configuration in which two ropes 11 are wound around the pulley 10 by a single-wrap system in the elevator of the 1:1 roping system are described. In the following calculation, tensions of the two ropes in each of cases in which depths of the two grooves are equal to and different from each other are obtained by changing the car position.

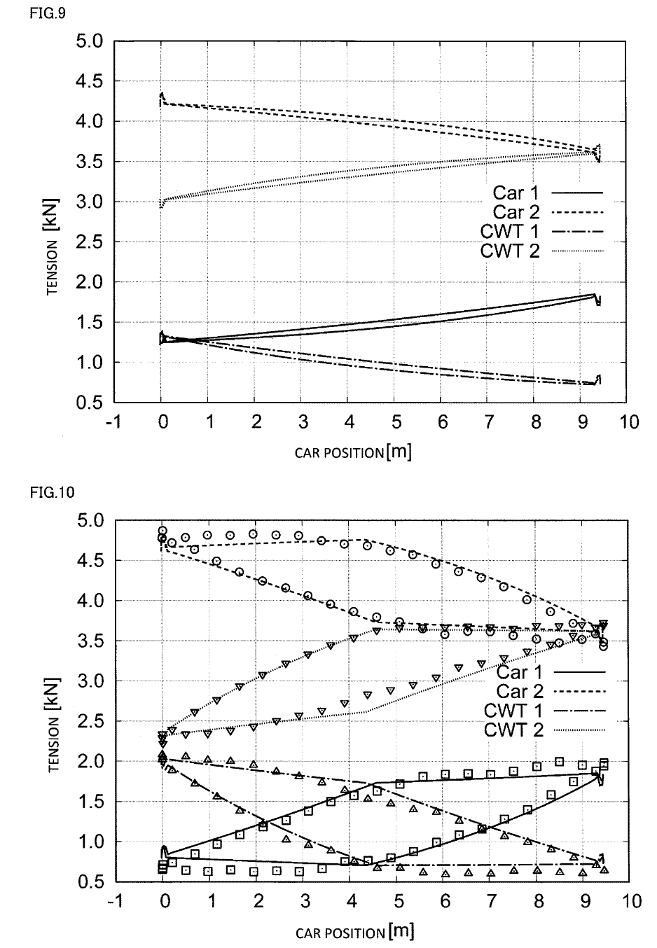

FIG. 8 is a graph for showing a relationship between the tensions of the two ropes 11 and the car position in the case in which the depths of the two grooves are equal to each other. FIG. 9 is a graph for showing a relationship between the tensions of the two ropes 11 and the car position in a case in which the depths of the two grooves differ from each other by 0.2 mm. FIG. 10 is a graph for showing a relationship between calculated values of the tensions of the two ropes 11 and the car position in a case in which the depths of the two grooves differ from each other by 0.7 mm in comparison to a plurality of actually measured values.

In FIG. 8, FIG. 9, and FIG. 10, the car 12 is traveling back and forth from an uppermost floor to a lowermost floor. Further, Car 1 represents the tension of the car-side portion of one rope 11. Car 2 represents the tension of the car-side portion of the other rope 11. CWT 1 represents the tension of the counterweight-side portion of the one rope 11. CWT 2 represents the tension of the counterweight-side portion of the other rope 11. Further, the actually measured value of each tension is a value obtained by measuring a tension acting on a shackle spring.

When the depths of the two grooves are equal to each other, as shown in FIG. 8, each tension assumes a constant value regardless of the car position.

In contrast, the fact that the depths of the two grooves are different from each other corresponds to the fact that the radius R of the pulley 10 in the equation of motion is different for each rope 11. When there is a difference between the depths of the two grooves, as shown in FIG. 9, the tension exhibited when the car 12 is raised and the tension exhibited when the car 12 is lowered draw mutually different loci. In FIG. 9, the grooves corresponding to Car 2 and CWT 2 are deeper than the grooves corresponding to Car 1 and CWT 1.

Supposing that the winding amount is calculated through use of a model that does not take the rope extension amount into consideration, even under a condition that the groove depths are the same, the tension changes with a change in car position due to presence of an initial extension amount difference of the rope indicating a deviation of an initial tension. Therefore, a result thereof is different from an actual tension behavior in which the tension does not change depending on the car position.

When the difference between the depths of the two grooves increases, a tension ratio between the winding-side portion and the unwinding-side portion exceeds the maximum traction ratio τ, and the rope 11 slips against the pulley 10, and as shown in FIG. 10, a slope of the tension fluctuation changes at some midpoint. It is understood from FIG. 10 that according to the analysis method in the first embodiment, it is possible to calculate the tension fluctuation as well as a rope slip behavior with high accuracy.

The maximum traction ratio Γ is the function of the friction coefficient between the pulley 10 and the rope 11, and hence when the friction coefficient changes, the maximum traction ratio Γ also changes. This change in maximum traction ratio Γ appears as a deviation of an inflection point at which the slope of the tension fluctuation changes. Therefore, it is also possible to obtain a fluctuation amount of the friction coefficient by grasping an amount of deviation of the inflection point.

FIG. 11 is a configuration diagram for schematically illustrating the elevator of the 1:1 roping system in which a plurality of ropes 11 are wound around the pulley 10 by a double-wrap system. In the double-wrap system, each rope 11 is wrapped two times around the pulley 10 which is a traction sheave and a deflector sheave 16. According to the analysis method in the first embodiment, the calculation can be performed for the double-wrap system as well.

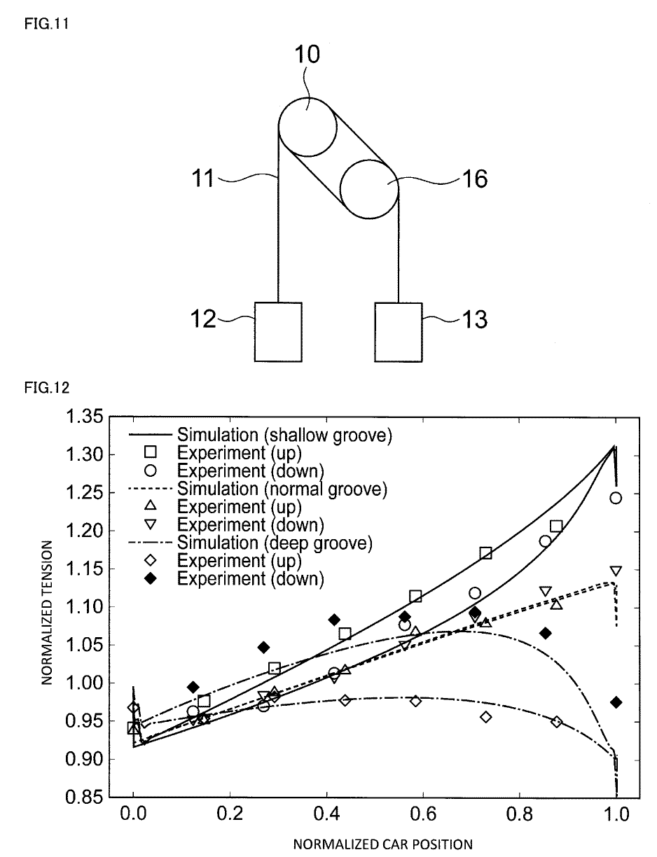

FIG. 12 is a graph for showing a relationship between calculated values of the tensions in the elevator of FIG. 11 and the car position in comparison to a plurality of actually measured values. The horizontal axis of FIG. 12 represents a value obtained by rendering the car position normalized by a travel distance. The vertical axis of FIG. 12 represents a value obtained by rendering the tension normalized by an average tension at an intermediate floor.

In this case, the rope 11 that passes through a groove having a normal depth is set as “normal-groove rope,” the rope 11 that passes through a groove shallower than the normal depth is set as “shallow-groove rope,” and the rope 11 that passes through a groove deeper than the normal depth is set as “deep-groove rope.”

In FIG. 12, the solid line represents a calculation result of the tension of the shallow-groove rope. Symbol represents an actually measured value of the tension of the shallow-groove rope at the time of raising the car. Symbol “o” represents an actually measured value of the tension of the shallow-groove rope at the time of lowering the car.

The dotted line represents a calculation result of the tension of the normal-groove rope. Symbol “A” represents an actually measured value of the tension of the normal-groove rope at the time of raising the car. Symbol “V” represents an actually measured value of the tension of the normal-groove rope at the time of lowering the car.

The one-dot chain line represents a calculation result of the tension of the deep-groove rope. Symbol “⋄” represents an actually measured value of the tension of the deep-groove rope at the time of raising the car. Symbol “♦” represents an actually measured value of the tension of the deep-groove rope at the time of lowering the car.

As shown in FIG. 12, it has been confirmed that even in a complicated system configuration such as the double-wrap system, the tension can be calculated with high accuracy through use of the tension model serving as the analysis model.

In a simple system configuration in which the number of pulleys 10 is one, as a tension calculation scheme in the first embodiment, it is possible to calculate the tension fluctuation by a static analysis using only the force balance without carrying out an analysis in which the equation of motion is numerically integrated, that is, a time response analysis.

The static analysis as used herein refers to a static analysis using an equation of motion in which an inertial term due to an inertial element and a damping term due to a damping element are deleted. The equation of motion generally includes an inertial term due to an inertial element, a rigidity term due to a rigidity element, and a damping term due to a damping element, and an analysis using this equation of motion is referred to as “dynamic analysis.” However, herein and in the appended claims, the equation based on the force balance in the static analysis is also included in the category of the equation of motion by being regarded as a special case of the equation of motion.

However, when a complicated system configuration including a plurality of pulleys, such as the deflector sheave 16 and a suspension sheave in a 2:1 roping system, that move in conjunction with the pulley 10 which is a traction sheave is employed, it is required to obtain rotation amounts of the plurality of pulleys that move in conjunction by convergence calculation. Thus, it is not possible to easily obtain the force balance condition by the static analysis.

Therefore, in the tension calculation scheme in the first embodiment, in the case of the complicated system configuration including the plurality of pulleys that move in conjunction with the pulley 10, the convergence calculation is carried out so as to constantly satisfy the equation of motion by numerically integrating the equation of motion, and the rotation amounts of the plurality of pulleys that move in conjunction are obtained as time history responses.

FIG. 13 is an explanatory diagram for illustrating a relationship between the tension model and input/output data in the first embodiment. In a state monitoring method according to the first embodiment, discrete tension data and a plurality of parameters are input to such a tension model as described above. Accordingly, continuous tension data is output.

The plurality of parameters include a plurality of types of data regarding rope specifications and data regarding a groove wear amount.

The plurality of types of data regarding the rope specification include the Young's modulus E, the cross-sectional area A, a rope diameter “d”, a linear density ρ, the number of ropes N, and a shackle rigidity ks. At least one of those pieces of data, for example, the rope diameter “d”, may be a fixed value. The data regarding the groove wear amount is an actually measured value of the depth of each groove.

The discrete tension data includes information on an actually measured value of the tension of each rope 11 in a state in which the car 12 is positioned at a measurement position in a hoistway, a rope number, and the measurement position. The measurement position, that is, the car position at which the tension is measured is, for example, an intermediate floor or the lowermost floor. The measurement position may also be two or more positions. The actually measured value of each tension is associated with the rope number and the measurement position. The actually measured value of each tension is, for example, a value read from a tension meter installed on a rope in a vicinity of a shackle.

It is not always required to measure the tensions of all the ropes 11 at the same car position.

Further, when the car 12 is positioned at the uppermost floor, the tensions of only the rope having the largest tension and the rope having the smallest tension may be measured without measuring the tensions of all the ropes 11. The rope having the largest tension is a rope having a maximum deformation amount of the shackle spring. The rope having the smallest tension is a rope having a minimum deformation amount of the shackle spring. In this case, it is also possible to regard the remaining ropes as one spring, and perform equivalent evaluation on a configuration in which the car 12 is suspended by three ropes.

The continuous tension data is continuous data on the tensions of all the ropes at all the car positions. Through use of the tension model in the first embodiment, the continuous tension data can be obtained from the discrete tension data. The continuous tension data includes the tensions of all the ropes at car positions that are not involved in actual measurement, the rope numbers, and the car positions. The calculated value of each tension is associated with the rope number and the car position.

The state monitoring method for an elevator according to the first embodiment includes a tension calculation step. In the tension calculation step, the winding-side portion and the unwinding-side portion of each of the plurality of ropes 11 with respect to the pulley 10 are respectively modeled as springs. Then, the tension of each of the plurality of ropes is calculated through use of a tension model formed of a plurality of equations of motion corresponding to those models. The plurality of ropes 11 are wrapped around the pulley 10, and suspend the car 12 and the counterweight 13.

The tension model uses the discrete tension data and the plurality of parameters as input data and the continuous tension data as output data. In addition, in the tension model, the rope free length ΔL is set as the displacement amount given to a pulley-side end portion, that is, the upper end of each winding-side portion. The rope free length ΔLi assumes a value obtained by subtracting the rope extension amount Δu within the winding amount Δx from the winding amount Δx by the pulley 10.

A state monitoring program according to the first embodiment is a program for causing a computer to execute the state monitoring method including the tension estimation method described above.

That is, the state monitoring program is a program for causing a computer to execute tension estimation processing. In the tension estimation processing, the tension of each of the plurality of ropes is calculated through use of the above-mentioned tension model.

Further, a program is generally stored in a readable format in a storage medium (for example, memory 202 of FIG. 33) serving as a recording medium. Then, processing described in the program read from the storage medium is executed by the computer. A recording medium according to the first embodiment is a computer-readable recording medium having recorded thereon the state monitoring program for an elevator for causing a computer to execute the state monitoring method including the tension estimation method described above.

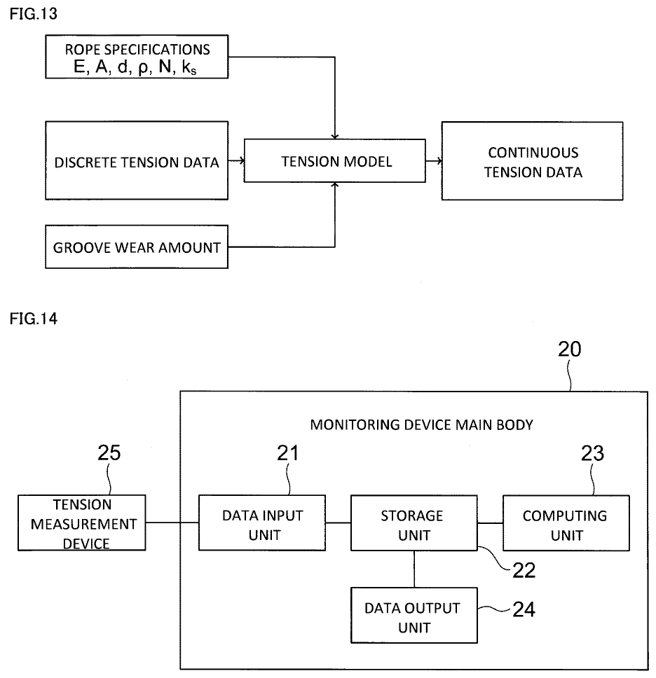

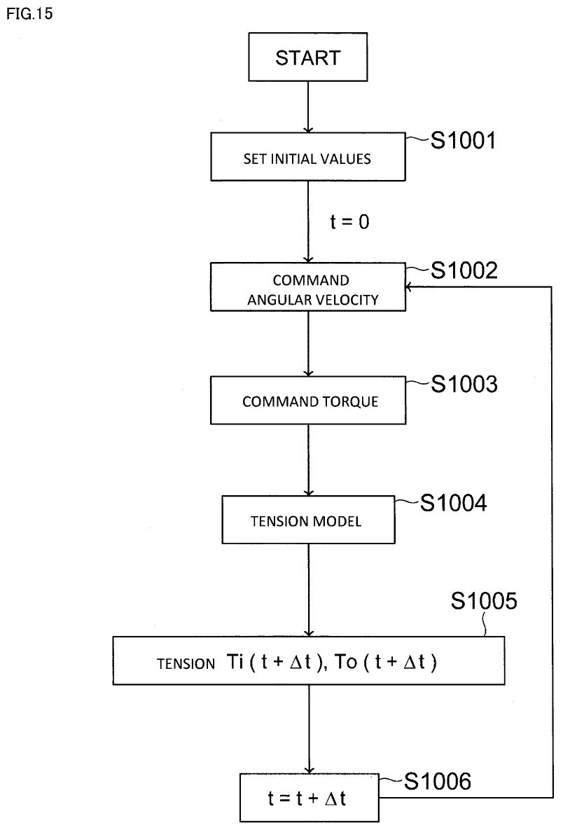

FIG. 14 is a block diagram for illustrating a state monitoring device for an elevator according to the first embodiment. The state monitoring device includes a monitoring device main body 20. The monitoring device main body 20 includes, as functional blocks, a data input unit 21, a storage unit 22, a computing unit 23, and a data output unit 24.

The data input unit 21 receives input of the discrete tension data from a tension measurement device 25. The data input unit 21 also receives input of the plurality of types of data regarding the rope specifications and the data regarding the groove wear amount.

The storage unit 22 stores the data input to the data input unit 21. The storage unit 22 also stores a result of computation performed by the computing unit 23.

The computing unit 23 calculates the continuous tension data based on the discrete tension data, the plurality of types of data regarding the rope specifications, and the data regarding the groove wear amount. The data output unit 24 outputs the continuous tension data calculated by the computing unit 23 to the outside.

FIG. 15 is a flow chart for illustrating an operation of the computing unit of FIG. 14. In Step S1001, the discrete tension data, the plurality of types of data regarding the rope specifications, and the data regarding the groove wear amount are set as initial values. After the time “t” is set to zero, in Step S1002, a command angular velocity to be provided to the pulley 10 in order to move the car 12 is calculated.

Subsequently, in Step S1003, a command torque is calculated so that the pulley 10 follows the command angular velocity, and is provided as the input data to the tension model. In Step S1004 and Step S1005, the equation of motion is time-integrated to calculate tension data Ti(t+Δt) on the winding side and tension data To(t+Δt) on the unwinding side at the next time step t+Δt.

After that, in Step S1006, the time “t” is reset to t+Δt, to thereby sequentially calculate a state at the next time step. Through iterations of the above-mentioned steps, the tensions at all the car positions can be obtained as the continuous tension data.

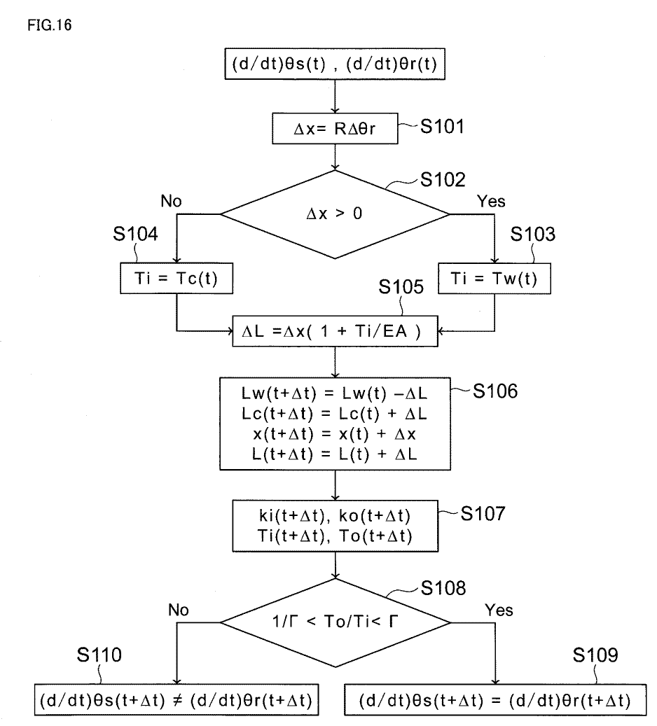

FIG. 16 is a flow chart for illustrating an operation of a processing part of the tension model of FIG. 15. In Step S101, the minute winding amount Δx is obtained from Expression (1.25) or Expression (1.34) through use of the rope angle θr on the pulley 10 out of an angular velocity (d/dt)θs(t) of the pulley 10 and an angular velocity (d/dt)θr(t) of the rope on the pulley at the time “t”.

Then, in Step S102, the computing unit 23 determines whether or not the winding amount Δx is larger than 0. That is, the computing unit 23 determines the traveling direction of the car 12. In this case, when Δx is positive, the car is lowered, and when Δx is negative, the car is raised.

When Δx is larger than 0, the car 12 is being lowered, and the computing unit 23 sets the tension Tw of the counterweight-side portion as the tension Ti of the winding-side portion in Step S103 as indicated in Expression (1.31). When Δx is not larger than 0, the car 12 is being raised, and the computing unit 23 sets the tension Tc of the car-side portion as the tension Ti of the winding-side portion in Step S104 as indicated in Expression (1.39).

After that, in Step S105, the computing unit 23 calculates the rope free length ΔL based on Expressions (1.43). Subsequently, in Step S106, the computing unit 23 calculates the car-side rope length Lc and the counterweight-side rope length Lw as values at the time t+Δt through use of Expressions (1.42) based on the rope free length ΔL. In addition, a winding amount “x” of the rope 11 on the pulley 10 and the rope free length L on the pulley 10 corresponding to the winding amount “x” are calculated as values at the time t+Δt from Expressions (1.29).

Then, in Step S107, the computing unit 23 calculates the rope rigidity ki of the winding-side portion at the time t+Δt from Expression (1.31) or Expression (1.39) and the rope rigidity ko of the unwinding-side portion from Expression (1.32) or Expression (1.40) based on the length Li of the winding-side portion and the length Lo of the unwinding-side portion using Expressions (1.28) or Expressions (1.37). Further, the computing unit 23 calculates the tension Ti of the winding-side portion at the time t+Δt from Expression (1.31) or Expression (1.39), and calculates the tension To of the unwinding-side portion from Expression (1.32) or Expression (1.40).

After that, in Step S108, the computing unit 23 determines whether or not the tension ratio To/Ti satisfies Expression (1.22). Then, when Expression (1.22) is satisfied, the computing unit 23 determines in Step S109 that no slip has occurred between the pulley 10 and the rope 11, and executes the processing of Expression (1.23).

Meanwhile, when Expression (1.22) is not satisfied, the computing unit 23 determines in Step S110 that a slip has occurred between the pulley 10 and the rope 11, and executes the processing of Expression (1.24).

Through the above-mentioned processing, the angle θs and the angular velocity (d/dt)θs of the pulley 10, and the angle θr and the angular velocity (d/dt)θr with respect to the rope 11 on the pulley 10 at the next time step t+Δt can be obtained, and at the same time, the tension Ti on the winding side and the tension To on the unwinding side can be obtained.

In the state monitoring method, the state monitoring program, the recording medium, and the state monitoring device described above, the winding-side portion and the unwinding-side portion of each of the plurality of ropes 11 with respect to the pulley 10 are respectively modeled as springs. Then, the tension of each of the plurality of ropes is calculated through use of a tension model formed of a plurality of equations of motion. Further, the tension model uses the discrete tension data as the input data and the continuous tension data as the output data.

Therefore, the calculation load is low, and the tension fluctuation at each car position for all the ropes 11 can be easily calculated by simple processing.

Further, in the tension model, the rope free length ΔL is set as the displacement amount given to the pulley-side end portion, that is, the upper end of each winding-side portion. Therefore, a more accurate tension can be estimated by simple processing.

Further, the maximum value of the tension and the fluctuation amount of the tension due to a change in car position can be grasped more accurately. Thus, it is possible to monitor whether those values are within an allowable range, and when the values fall out of the allowable range, maintenance and inspection are carried out, to thereby be able to appropriately manage the tension of each rope 11.

Further, the tension model uses, as the input data, the actually measured value of the depth of each of the plurality of grooves formed in the pulley 10. Therefore, a more accurate tension can be estimated.

Further, the rope extension amount Δu assumes a value proportional to the rope free length ΔL and the tension Ti of the winding-side portion. Therefore, the rope extension amount Δu can be calculated more accurately, thereby enabling estimation of an accurate tension.

Further, the rope free length ΔL is the function of the winding amount Δx and the tension Ti of the winding-side portion. Therefore, the rope extension amount Δu with respect to the winding amount Δx can be calculated more accurately, thereby enabling more accurate calculation of the tension Ti of the winding-side portion.

Further, the length of the winding-side portion and the length of the unwinding-side portion are each calculated from the free rope length ΔL. Therefore, the winding-side portion becomes shorter by the free rope length ΔL that has been wound, and the unwinding-side portion becomes longer. Therefore, a more accurate tension can be estimated.

That is, in the tension model, the rope free length ΔL which assumes a value obtained by subtracting the rope extension amount within the winding amount from the winding amount by the pulley can be set as the displacement amounts given to the pulley-side end portions of the winding-side portion and the unwinding-side portion, thereby enabling estimation of a more accurate tension.

Further, the tension Ti of the winding-side portion is calculated from the displacement difference between the upper end and the lower end of the winding-side portion, and the tension To of the unwinding-side portion is calculated from the displacement difference between the upper end and the lower end of the unwinding-side portion. Therefore, a more accurate tension can be estimated.

Further, the rope rigidity ki of the winding-side portion is the function of the Young's modulus E, the cross-sectional area A, and the length Li of the winding-side portion. In addition, the rope rigidity ko of the unwinding-side portion is the function of the Young's modulus E, the cross-sectional area A, and the length Lo of the unwinding-side portion. Therefore, the rope rigidity ki of the winding-side portion and the rope rigidity ko of the unwinding-side portion can be calculated more accurately.

### Second Embodiment

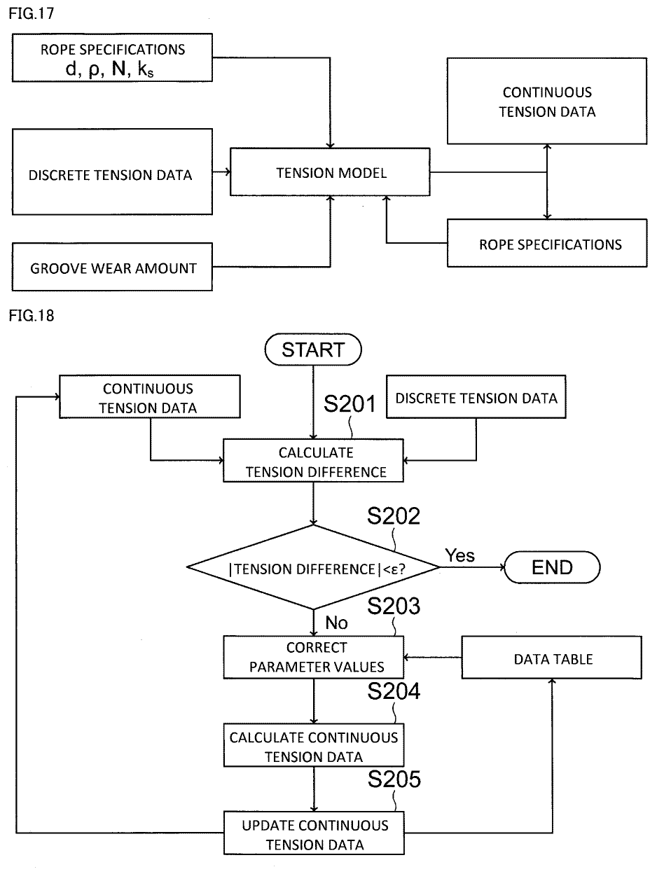

Next, FIG. 17 is an explanatory diagram for illustrating a relationship between a tension model and input/output data in a second embodiment of this disclosure. The plurality of types of data regarding the rope specifications include the Young's modulus E, the cross-sectional area A, the rope diameter “d”, the linear density ρ, the number of ropes N, and the shackle rigidity ks. Of those, the Young's modulus E and the cross-sectional area A are subjected to an aging. When the Young's modulus E and the cross-sectional area A change, a deviation occurs between the continuous tension data and the discrete tension data.

In contrast thereto, in the second embodiment, the value of the Young's modulus E and the value of the cross-sectional area A which are parameter values of each rope 11 are each identified through convergence by iterative computation so that the continuous tension data and the discrete tension data match each other. A basic configuration of a state monitoring device according to the second embodiment is the same as that of FIG. 14.

FIG. 18 is a flow chart for illustrating a part of an operation of the state monitoring device according to the second embodiment. In addition to the same operation as that in the first embodiment, the state monitoring device periodically executes parameter value updating processing illustrated in FIG. 18 so that the continuous tension data and the discrete tension data match each other. Computation of the parameter value updating processing is generally called parameter estimation or parameter identification.

In Step S201, the monitoring device main body 20 calculates, for each rope 11, the difference between the continuous tension data and the discrete tension data, that is, the tension difference at the same car position.

Subsequently, in Step S202, the monitoring device main body 20 determines whether or not the absolute value of the tension difference is smaller than a difference threshold value ε. The difference threshold value ε is a minute value set in advance in the monitoring device main body 20. When the tension difference is smaller than the difference threshold value E, the monitoring device main body 20 ends the processing for the relevant round.

When the tension difference is equal to or larger than the difference threshold value ε, in Step S203, the monitoring device main body 20 corrects the parameter values. The parameter values are the value of the Young's modulus E and the value of the cross-sectional area A.

At this time, the monitoring device main body 20 uses, for the tension model, a data table in which results of the calculation using a plurality of different parameter values are stored. The monitoring device main body 20 performs interpolation to estimate, from the data table, the parameter values that minimize the tension difference.

After that, in Step S204, the monitoring device main body 20 calculates new continuous tension data through use of the corrected parameters. Then, in Step S205, the monitoring device main body 20 updates the continuous tension data, and the process returns to the processing step of Step S201. The above-mentioned processing is repeated until the absolute value of the tension difference becomes smaller than the difference threshold value ε, to thereby be able to identify the parameter values after an aging and update the parameter values.

A state monitoring method according to the second embodiment includes the same tension calculation step as that of the first embodiment and a parameter value updating step. The parameter value updating step is a step of updating, when the difference between the continuous tension data and the discrete tension data is equal to or larger than the difference threshold value ε, at least one of the value of the Young's modulus E or the value of the cross-sectional area A so that the continuous tension data and the discrete tension data match each other.

A state monitoring program according to the second embodiment is a program for causing a computer to execute the above-mentioned state monitoring method.

Further, a recording medium according to the second embodiment is a computer-readable recording medium having recorded thereon the state monitoring program for an elevator for causing a computer to execute the above-mentioned state monitoring method. The state monitoring program is stored in a readable format in a storage medium (for example, memory 202 of FIG. 33) serving as a recording medium. Then, processing described in the state monitoring program read from the storage medium is executed by the computer.

In the state monitoring method, the state monitoring program, the recording medium, and the state monitoring device described above, the value of the Young's modulus E and the value of the cross-sectional area A are updated in accordance with the aging of each rope 11. The Young's modulus E and the cross-sectional area A affect the rope rigidity, and hence the tension of each rope 11 can be estimated more accurately.

Further, the identified cross-sectional area A of each rope 11 can be used as an index for determining a deterioration state of each rope 11. For example, when the identified cross-sectional area A falls below an allowable value, the maintenance and inspection are carried out, and depending on the state of the rope 11, the rope is replaced.

Of the plurality of types of data regarding the specifications of the rope 11, values that are subjected to an aging include the rope diameter “d” in addition to the Young's modulus E and the cross-sectional area A. When the rope diameter “d” changes, the winding amount of the rope 11 on the pulley 10 changes in the same manner as when the groove depth in the pulley 10 changes, thereby affecting the tension. Therefore, the rope diameter “d” may be identified through convergence by iterative computation so that the continuous tension data and the discrete tension data match each other.

Further, while the groove wear amount does not change depending on the car position, the rope diameter “d” assumes a value that varies depending on the car position because the number of times that the rope has been bent varies for each rope section. Such a difference in rope diameter “d” depending on the car position can also be calculated by comparing the difference between the continuous tension data and the discrete tension data for each car position.

### Third Embodiment

Next, FIG. 19 is an explanatory diagram for illustrating a relationship between a tension model and input/output data in a third embodiment of this disclosure. Of the parameters to be input to the tension model, the groove wear amount is subjected to an aging. When the groove wear amount changes, a deviation occurs between the continuous tension data and the discrete tension data.

In contrast thereto, in the third embodiment, the value of the groove wear amount of each groove is identified through convergence by: iterative computation so that the continuous tension data and the discrete tension data match each other. A basic configuration of a state monitoring device according to the third embodiment is the same as that of FIG. 14.

A state monitoring method according to the third embodiment includes the same tension calculation step as that of the first embodiment and a parameter value updating step. The parameter value updating step is a step of updating, when the difference between the continuous tension data and the discrete tension data is equal to or larger than the difference threshold value ε, each groove wear amount so that the continuous tension data and the discrete tension data match each other.

Specific details of the parameter value updating step are details of the description given with reference to FIG. 18 in which the Young's modulus E and the cross-sectional area A are replaced by the groove wear amount.

A state monitoring program according to the third embodiment is a program for causing a computer to execute the above-mentioned state monitoring method.

Further, a recording medium according to the third embodiment is a computer-readable recording medium having recorded thereon the state monitoring program for an elevator for causing a computer to execute the above-mentioned state monitoring method. The state monitoring program is stored in a readable format in a storage medium (for example, memory 202 of FIG. 33) serving as a recording medium. Then, processing described in the state monitoring program read from the storage medium is executed by the computer.

In the state monitoring method, the state monitoring program, the recording medium, and the state monitoring device described above, the value of each groove wear amount is updated in accordance with the aging of the pulley 10. Thus, the tension of each rope 11 can be estimated more accurately.

Further, when a difference between the groove wear amounts of a plurality of grooves is equal to or larger than an allowable amount, groove polishing work for equalizing the depths of the plurality of grooves can be carried out at an appropriate timing.

Further, each identified groove wear amount can be used as an index for determining a deterioration state of the pulley 10. For example, when the groove wear amount of at least one of the grooves exceeds an allowable value, a command for requesting replacement of the pulley 10 may be issued.

The initial value of each groove wear amount may be a value identified from the discrete tension data instead of the actually measured value. Therefore, it is possible to omit measurement work of the groove depth.

Further, both the parameter value updating step in the second embodiment and the parameter value updating step in the third embodiment may be executed.

### Fourth Embodiment

Next, a fourth embodiment of this disclosure is described. A basic configuration of a state monitoring device according to the fourth embodiment is the same as that of FIG. 14. However, in the fourth embodiment, the state monitoring device is a server. That is, the state monitoring device is placed remotely from an elevator to be subjected to maintenance work.

The discrete tension data and the data regarding the groove wear amount are transmitted from a maintenance work site to the state monitoring device through a communication network line. Data is transmitted to and received from the state monitoring device at the maintenance work site through communication equipment carried by a maintenance worker or an elevator control panel.

In the fourth embodiment, the plurality of types of data regarding the rope specifications are incorporated into the tension model as fixed values. That is, the plurality of types of data regarding the rope specifications are stored in advance in the monitoring device main body 20 by the storage unit 22.

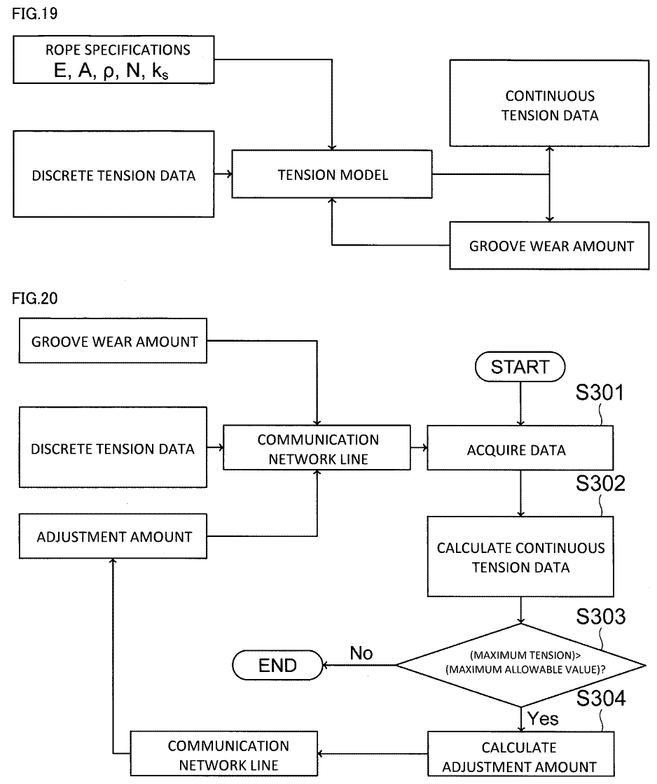

FIG. 20 is a flow chart for illustrating a part of an operation of the state monitoring device according to the fourth embodiment. The monitoring device main body 20 executes adjustment amount transmission processing illustrated in FIG. 20 during the maintenance and inspection of the elevator.

In Step S301, the monitoring device main body 20 acquires the discrete tension data and the data regarding the groove wear amount through the communication network line. The discrete tension data and the data regarding the groove wear amount are transmitted from the maintenance work site to the monitoring device main body 20 through the communication network line.

In Step S302, the monitoring device main body 20 calculates the continuous tension data. Then, in Step S303, the monitoring device main body 20 determines whether or not the maximum value of the tension included in the continuous tension data, that is, a maximum tension, exceeds a maximum allowable value. In the monitoring device main body 20, the maximum allowable value is set in advance as a tension allowable value.

When the maximum tension exceeds the maximum allowable value, in Step S304, the monitoring device main body 20 calculates an adjustment amount for the tension so that the maximum tension becomes equal to or smaller than the maximum allowable value. Then, the monitoring device main body 20 transmits the adjustment amount to the maintenance work site through the communication network line.

The maintenance worker adjusts the tension of each rope 11 based on the received adjustment amount, and transmits the discrete tension data after the adjustment to the monitoring device main body 20.

When the maximum tension is equal to or smaller than the maximum allowable value in Step S303, the monitoring device main body 20 ends the adjustment amount transmission processing.

A state monitoring method according to the fourth embodiment includes the same tension calculation step as that of the first embodiment and an adjustment amount transmission step. The adjustment amount transmission step is a step of determining whether or not the tension of each rope 11 falls out of the tension allowable value based on the continuous tension data, and transmitting the calculated adjustment amount for the tension when the tension falls out of the tension allowable value.

A state monitoring program according to the fourth embodiment is a program for causing a computer to execute the above-mentioned state monitoring method.

Further, a recording medium according to the fourth embodiment is a computer-readable recording medium having recorded thereon the state monitoring program for an elevator for causing a computer to execute the above-mentioned state monitoring method. The state monitoring program is stored in a readable format in a storage medium (for example, memory 202 of FIG. 33) serving as a recording medium. Then, processing described in the state monitoring program read from the storage medium is executed by the computer.

In the state monitoring method, the state monitoring program, the recording medium, and the state monitoring device described above, when the maximum tension exceeds the allowable value, the adjustment amount for the tension is transmitted to the maintenance work site. Therefore, tension adjustment work can be easily performed, thereby being able to achieve the reduction in maintenance work time. It is also possible to suppress reduction in life of each rope 11 by setting the tension of each rope 11 to an appropriate level.

Reacquisition of the discrete tension data after tension adjustment may be omitted.

Further, the elevator to be subjected to the maintenance work may have the tension of each rope 11 measured at a preset cycle and transmitted to the state monitoring device as the discrete tension data. Further, a groove depth measurement device that measures the depth of each groove in the pulley 10 may be installed in a vicinity of the pulley 10.

Then, the elevator may have the depth of each groove measured at a preset cycle and transmitted to the state monitoring device as the data regarding the groove wear amount.

In this case, the monitoring device main body 20 may execute the adjustment amount transmission processing at a timing at which the discrete tension data and the data regarding the groove wear amount are received. During the maintenance work, the maintenance worker can adjust the tension of each rope 11 based on the adjustment amount transmitted by the most recent adjustment amount transmission processing.

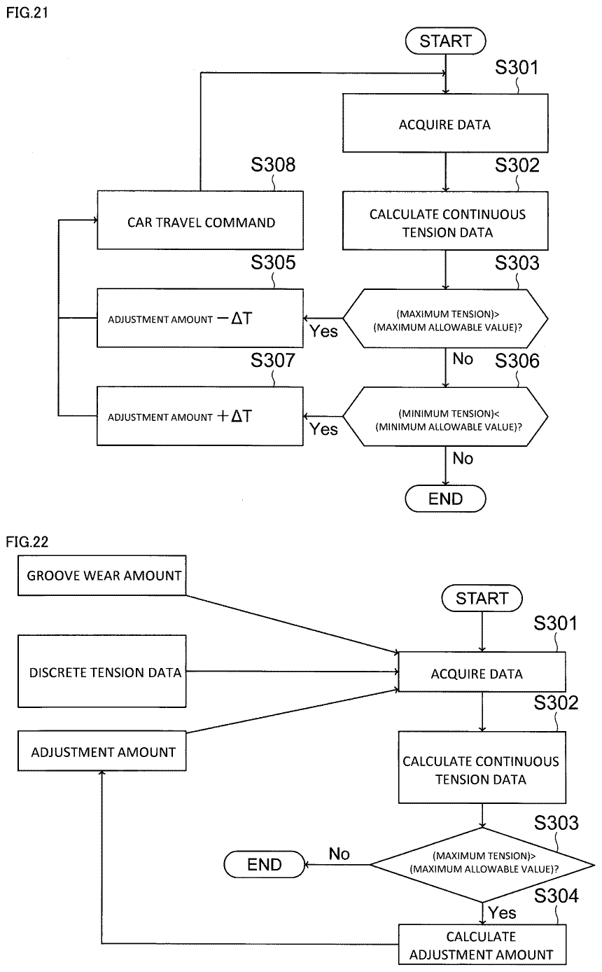

FIG. 21 is a flow chart for illustrating a part of an operation of a state monitoring device according to a first modification example of the fourth embodiment. In the adjustment amount transmission processing in the first modification example, a minute adjustment amount that has been set in advance is transmitted to the elevator one or more times.

When the maximum tension exceeds the maximum allowable value in Step S303, in Step S305, the monitoring device main body 20 in the first modification example transmits-AT as the adjustment amount for the tension to the maintenance work site.

Further, when the maximum tension is equal to or smaller than the maximum allowable value, the monitoring device main body 20 determines in Step S306 whether a minimum value of the tension included in the continuous tension data, that is, a minimum tension, is smaller than a minimum allowable value. The minimum allowable value is set in advance in the monitoring device main body 20 as the tension allowable value.

When the minimum tension is smaller than the minimum allowable value, in Step S307, the monitoring device main body 20 transmits+ΔT as the adjustment amount for the tension to the maintenance work site. The value of ΔT is set in advance in the monitoring device main body 20.

After the adjustment amount for the tension is transmitted in Step S305 or Step S307, in Step S308, the monitoring device main body 20 transmits a car travel command to the maintenance work site.

The maintenance worker adjusts the tension of each rope 11 based on the received adjustment amount, then causes the car 12 to travel back and forth one time, and transmits the discrete tension data after the adjustment to the monitoring device main body 20.

Such tension adjustment is repeatedly performed until the maximum tension becomes equal to or smaller than the maximum allowable value and the minimum tension becomes equal to or larger than the minimum allowable value.

The adjustment amount transmission step in the first modification example is a step of determining whether or not the tension of each rope 11 falls out of the tension allowable value based on the continuous tension data, and when the tension falls out of the tension allowable value, transmitting the adjustment amount for the tension that has been set in advance.

FIG. 22 is a flow chart for illustrating a part of an operation of a state monitoring device according to a second modification example of the fourth embodiment. The state monitoring device in the second modification example is a portable computer carried by the maintenance worker in place of the server.

Therefore, the calculated adjustment amount is displayed on the state monitoring device itself. In addition, the data regarding the groove wear amount and the discrete tension data are directly input to the state monitoring device.

According to the state monitoring device of the second modification example, it is possible to easily adjust the tension even for an elevator that is not connected to a network by performing the same processing as that performed by the server.

### Fifth Embodiment

Next, a fifth embodiment of this disclosure is described. A basic configuration of a state monitoring device according to the fifth embodiment is the same as that of FIG. 14. In addition, the state monitoring device according to the fifth embodiment is a server.

The elevator to be subjected to the maintenance work has the tension of each rope 11 measured at a preset cycle and transmitted as the discrete tension data. The state monitoring device receives the discrete tension data through the communication network line.

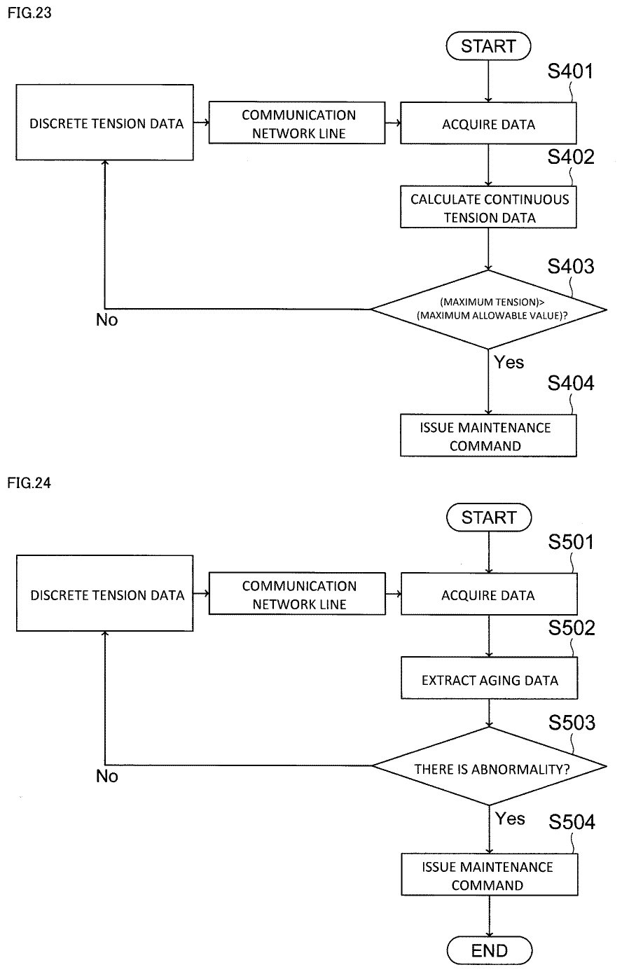

FIG. 23 is a flow chart for illustrating a part of an operation of the state monitoring device according to the fifth embodiment. In Step S401, the monitoring device main body 20 acquires the discrete tension data through the communication network line. The data regarding rope specifications and the data regarding the groove wear amount are stored in advance in the monitoring device main body 20.

In Step S402, the monitoring device main body 20 calculates the continuous tension data. Then, in Step S403, the monitoring device main body 20 determines whether or not the maximum value of the tension included in the continuous tension data, that is, a maximum tension, exceeds a maximum allowable value. In the monitoring device main body 20, the maximum allowable value is set in advance.

When the maximum tension exceeds the maximum allowable value, in Step S404, the monitoring device main body 20 issues a maintenance command, that is, issues a notification that the maintenance work is required, to the control room. When the maximum tension does not exceed the maximum allowable value, the monitoring device main body 20 waits for reception of the next discrete tension data.

A state monitoring method according to the fifth embodiment includes the same tension calculation step as that of the first embodiment and a maintenance command issuing step. The maintenance command issuing step is a step of determining, based on the continuous tension data, whether or not the tension of each rope 11 falls out of the tension allowable value, and when the tension falls out of the tension allowable value, issuing a notification that the maintenance work is required.

A state monitoring program according to the fifth embodiment is a program for causing a computer to execute the above-mentioned state monitoring method.

Further, a recording medium according to the fifth embodiment is a computer-readable recording medium having recorded thereon the state monitoring program for an elevator for causing a computer to execute the above-mentioned state monitoring method. The state monitoring program is stored in a readable format in a storage medium (for example, memory 202 of FIG. 33) serving as a recording medium. Then, processing described in the state monitoring program read from the storage medium is executed by the computer.

In the state monitoring method, the state monitoring program, the recording medium, and the state monitoring device described above, when the maximum tension exceeds the tension allowable value, the maintenance command is issued. Therefore, it is also possible to adjust the tension of each rope 11 at a more appropriate timing, and suppress reduction in life of each rope 11.

Further, excessive maintenance work can be prevented from being carried out, thereby being able to achieve appropriate allocation of maintenance workers.

Further, an object to be subjected to the maintenance work can be more clearly defined, thereby enabling the reduction in maintenance work time.

Further, through setting of the timing of the maintenance work to an appropriate timing, it is possible to suppress occurrence of vibrations, abnormal noise, and the like due to deterioration of elevator performance.

The tension allowable value in the fifth embodiment may be the minimum allowable value, or may be both the maximum allowable value and the minimum allowable value.

### Sixth Embodiment

Next, a sixth embodiment of this disclosure is described. A basic configuration of a state monitoring device according to the sixth embodiment is the same as that of FIG. 14. In addition, the state monitoring device according to the sixth embodiment is a server.

The elevator to be subjected to the maintenance work has the tension of each rope 11 measured at a preset cycle and transmitted as the discrete tension data. The state monitoring device receives the discrete tension data through the communication network line.

FIG. 24 is a flow chart for illustrating a part of an operation of the state monitoring device according to the sixth embodiment. In Step S501, the monitoring device main body 20 acquires the discrete tension data through the communication network line. The data regarding rope specifications and the data regarding the groove wear amount are stored in advance in the monitoring device main body 20.

After that, the monitoring device main body 20 calculates the continuous tension data, but this step is omitted in FIG. 24. Further, in Step S502, the monitoring device main body 20 extracts aging data. The aging data is current values of parameters that are subjected to an aging among the plurality of parameters to be input to the tension model.

The parameters that are subjected to an aging include the Young's modulus E of the rope 11, the cross-sectional area A of the rope 11, and the groove wear amount. The current values of those parameters can be identified by the method described in the second embodiment and the third embodiment.

Next, in Step S503, the monitoring device main body 20 determines whether or not there is an abnormality in the aging data. The monitoring device main body 20 has an aging allowable value set for each parameter that is subjected to an aging. The monitoring device main body 20 compares each parameter that is subjected to an aging to the corresponding aging allowable value. When there is an abnormality in the aging data, that is, there is a parameter that exceeds the aging allowable value, in Step S504, the monitoring device main body 20 issues the maintenance command. When there is no abnormality in the aging data, the monitoring device main body 20 waits for reception of the next discrete tension data.

A state monitoring method according to the sixth embodiment includes the same tension calculation step as that of the first embodiment and an aging monitoring step. The aging monitoring step is a step of determining whether or not a parameter that is subjected to an aging among the plurality of parameters falls out of the aging allowable value, and when the parameter falls out of the aging allowable value, issuing a notification that the maintenance work is required.

A state monitoring program according to the sixth embodiment is a program for causing a computer to execute the above-mentioned state monitoring method.

Further, a recording medium according to the sixth embodiment is a computer-readable recording medium having recorded thereon the state monitoring program for an elevator for causing a computer to execute the above-mentioned state monitoring method. The state monitoring program is stored in a readable format in a storage medium (for example, memory 202 of FIG. 33) serving as a recording medium. Then, processing described in the state monitoring program read from the storage medium is executed by the computer.

In the state monitoring method, the state monitoring program, the recording medium, and the state monitoring device described above, it is possible to detect deterioration of at least one of the rope 11 or the pulley 10 at an early stage, and carry out the maintenance work at a more appropriate time.

### Seventh Embodiment

Next, a seventh embodiment of this disclosure is described. A basic configuration of a state monitoring device according to the seventh embodiment is the same as that of FIG. 14. In addition, the state monitoring device according to the seventh embodiment is a server.

The discrete tension data and the data regarding the groove wear amount are transmitted from the maintenance work site to the state monitoring device through the communication network line. Data is transmitted to and received from the state monitoring device at the maintenance work site through communication equipment carried by the maintenance worker or the elevator control panel.

In the seventh embodiment, the plurality of types of data regarding the rope specifications are incorporated into the tension model as fixed values. That is, the plurality of types of data regarding the rope specifications are stored in advance in the monitoring device main body 20 by the storage unit 22.

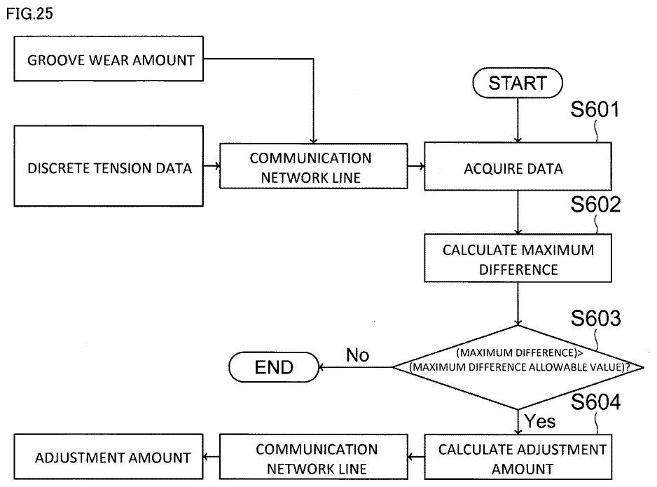

FIG. 25 is a flow chart for illustrating a part of an operation of the state monitoring device according to the seventh embodiment. The monitoring device main body 20 executes adjustment amount transmission processing illustrated in FIG. 25 during the maintenance and inspection of the elevator.

In Step S601, the monitoring device main body 20 acquires the discrete tension data and the data regarding the groove wear amount through the communication network line. The discrete tension data and the data regarding the groove wear amount are transmitted from the maintenance work site to the monitoring device main body 20 through the communication network line.

After that, the monitoring device main body 20 calculates the continuous tension data, but this step is omitted in FIG. 25. Further, in Step S602, the monitoring device main body 20 calculates a maximum difference which is a difference between the maximum value and the minimum value of the depth of the groove in the pulley 10.

Subsequently, in Step S603, the monitoring device main body 20 determines whether or not the maximum difference exceeds a maximum difference allowable value. The monitoring device main body 20 has the maximum difference allowable value set in advance therein.

When the maximum difference exceeds the maximum difference allowable value, in Step S604, the monitoring device main body 20 calculates the adjustment amount for the tension of each rope 11. Then, the monitoring device main body 20 transmits the adjustment amount for the tension through the communication network line.

The monitoring device main body 20 calculates the adjustment amount for the tension of each rope 11 so that the depths of the plurality of grooves become closer to a uniform value.

Specifically, the monitoring device main body 20 calculates the adjustment amount so as to lower the tension of the rope 11 corresponding to a groove having a large groove wear amount and raise the tension of the rope 11 corresponding to a groove having a small groove wear amount. When the tension of the rope 11 is raised, the groove wear amount of the corresponding groove becomes larger after the tension adjustment. When the tension of the rope 11 is lowered, the groove wear amount of the corresponding groove becomes smaller after the tension adjustment.

The maintenance worker adjusts the tension of each rope 11 based on the received adjustment amount.

When the maximum difference is equal to or smaller than the maximum difference allowable value in Step S603, the monitoring device main body 20 ends the adjustment amount transmission processing.

A state monitoring method according to the seventh embodiment includes the same tension calculation step as that of the first embodiment and the adjustment amount transmission step. The adjustment amount transmission step is a step of determining whether or not the maximum difference between the depths of the plurality of grooves falls out of the maximum difference allowable value, and when the maximum difference falls out of the maximum difference allowable value, transmitting the calculated adjustment amount for the tension.

A state monitoring program according to the seventh embodiment is a program for causing a computer to execute the above-mentioned state monitoring method.

Further, a recording medium according to the seventh embodiment is a computer-readable recording medium having recorded thereon the state monitoring program for an elevator for causing a computer to execute the above-mentioned state monitoring method. The state monitoring program is stored in a readable format in a storage medium (for example, memory 202 of FIG. 33) serving as a recording medium. Then, processing described in the state monitoring program read from the storage medium is executed by the computer.

In the state monitoring method, the state monitoring program, the recording medium, and the state monitoring device described above, when the maximum difference exceeds the maximum difference allowable value, the adjustment amount for the tension is transmitted to the maintenance work site. Therefore, tension adjustment work can be easily performed, thereby being able to achieve the reduction in maintenance work time.

Further, the depths of the plurality of grooves can be gradually made closer to a uniform value, thereby being able to achieve a longer life of the pulley 10. Further, when the longer life of the pulley 10 is achieved, it is possible to reduce time and labor required for pulley replacement and groove mechanical machining work.

Further, the tension difference between the plurality of ropes 11 caused by the difference between the depths of the grooves can be suppressed, thereby being able to achieve a longer life of each rope 11 as well.

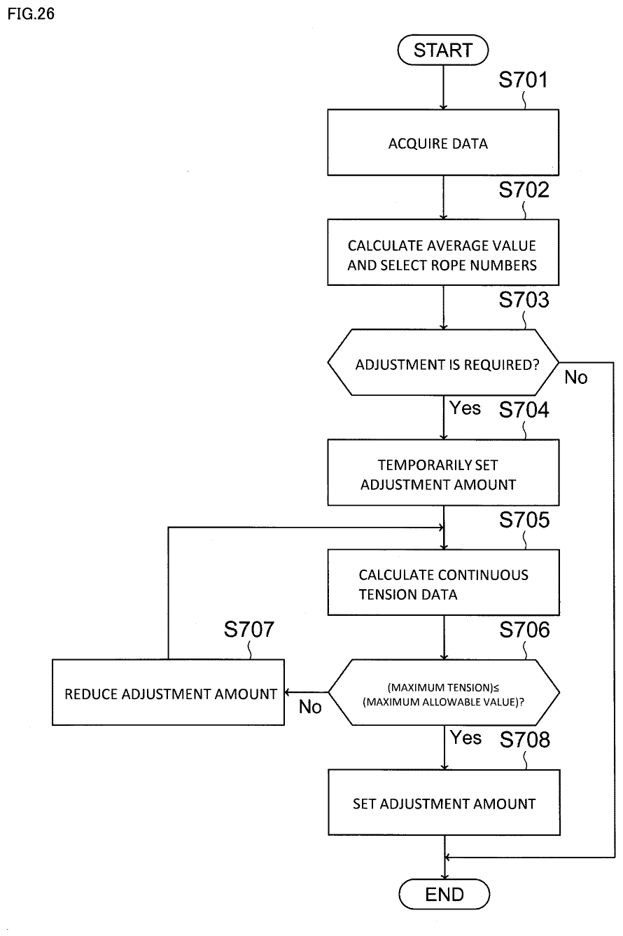

FIG. 26 is a flow chart for illustrating a part of an operation of a state monitoring device according to a modification example of the seventh embodiment.

In Step S701, the monitoring device main body 20 in the modification example acquires the discrete tension data and the data regarding the groove wear amount.

After that, the monitoring device main body 20 calculates the continuous tension data, but this step is omitted in FIG. 26. Further, in Step S702, the monitoring device main body 20 calculates an average value of the depths of the plurality of grooves, and selects a rope number “i” of the rope 11 corresponding to the deepest groove and a rope number “j” of the rope 11 corresponding to the shallowest groove.

Subsequently, in Step S703, the monitoring device main body 20 determines whether or not the tension adjustment is required through use of a depth difference allowable value. The monitoring device main body 20 has the depth difference allowable value set in advance therein.

Specifically, in Step S703, the monitoring device main body 20 determines whether or not a difference between the depth of the deepest groove and the average value exceeds the depth difference allowable value. Then, when the difference exceeds the depth difference allowable value, in Step S704, the monitoring device main body 20 temporarily sets-AT as the adjustment amount for the tension of the rope 11 having the rope number “i”.

In addition, in Step S703, the monitoring device main body 20 determines whether or not a difference between the depth of the shallowest groove and the average value exceeds the depth difference allowable value. Then, when the difference exceeds the depth difference allowable value, in Step S704, the monitoring device main body 20 temporarily sets+ΔT as the adjustment amount for the tension of the rope 11 having the rope number “j”.

When none of the difference between the depth of the deepest groove and the average value and the difference between the depth of the shallowest groove and the average value exceeds the depth difference allowable value, the monitoring device main body 20 determines that the tension adjustment is not required, and ends the processing for the relevant round.

When the adjustment amount ΔT for the tension is given, an overall rope tension behavior changes, and there is a possibility that the maximum tension after the adjustment exceeds the maximum allowable value. Therefore, in Step S705, the monitoring device main body 20 calculates the continuous tension data based on the temporarily set adjustment amount. Then, the monitoring device main body 20 determines whether or not the maximum tension is equal to or smaller than the maximum allowable value.

When the maximum tension exceeds the maximum allowable value, in Step S707, the monitoring device main body 20 reduces the adjustment amount. For example, when the temporarily set adjustment amount is +ΔT, a temporarily set value of the adjustment amount is corrected to +ΔT−t. Meanwhile, when the temporarily set adjustment amount is −ΔT, the temporarily set value of the adjustment amount is corrected to −ΔT+t. A reduction amount “t” is a value smaller than ΔT.

The monitoring device main body 20 repeats the processing steps of from Step S705 to Step S707 until the maximum tension becomes equal to or smaller than the maximum allowable value.

When the maximum tension is equal to or smaller than the maximum allowable value, in Step S708, the monitoring device main body 20 finally sets the adjustment amount, and transmits tension adjustment information in which the rope number and the adjustment amount are associated with each other to the elevator through the communication network line.

The maintenance worker adjusts the tension of each rope 11 based on the received adjustment amount. When the tension is lowered, a contact pressure acting on the groove decreases, and hence it is possible to reduce the groove wear rate. Meanwhile, when the tension is increased, the contact pressure acting on the groove increases, and hence it is possible to increase the groove wear rate.

A state monitoring method according to the modification example of the seventh embodiment includes the same tension calculation step as that of the first embodiment and the adjustment amount transmission step. In the adjustment amount transmission step, it is determined whether or not at least one of the difference between the depth of the deepest groove and the average value or the difference between the depth of the shallowest groove and the average value exceeds the depth difference allowable value. Then, when the depth difference allowable value is exceeded, the tension adjustment information is transmitted.

A state monitoring program according to the modification example of the seventh embodiment is a program for causing a computer to execute the above-mentioned state monitoring method.

Further, a recording medium according to the modification example of the seventh embodiment is a computer-readable recording medium having recorded thereon the state monitoring program for an elevator for causing a computer to execute the above-mentioned state monitoring method. The state monitoring program is stored in a readable format in a storage medium (for example, memory 202 of FIG. 33) serving as a recording medium. Then, processing described in the state monitoring program read from the storage medium is executed by the computer.

Even in the state monitoring method, the state monitoring program, the recording medium, and the state monitoring device described above, the tension adjustment work can be easily performed, thereby being able to achieve the reduction in maintenance work time.

Further, the continuous tension data is calculated based on the temporarily set adjustment amount, and the adjustment amount is corrected so that the maximum tension becomes equal to or smaller than the maximum allowable value. Therefore, it is possible to achieve equalization of the groove wear amount within an appropriate range of the tension fluctuation.

In the same manner as in the second modification example of the fourth embodiment described with reference to FIG. 22, the state monitoring device according to the seventh embodiment may be a portable computer carried by the maintenance worker in place of the server.

Further, in the adjustment amount transmission step in the fourth and seventh embodiments, it may be determined, before the adjustment amount is transmitted, whether or not the adjustment using the adjustment amount is feasible in terms of a thread allowance for a thread for the tension adjustment, a rope safety factor, and the like. Then, when the adjustment is determined to be unfeasible, a notification that the adjustment is impossible may be issued. The issuance of the notification that the adjustment is impossible allows the maintenance worker to mechanically machine each groove or replace the pulley 10.

### Eighth Embodiment

Next, an eighth embodiment of this disclosure is described. A basic configuration of a state monitoring device according to the eighth embodiment is the same as that of FIG. 14.

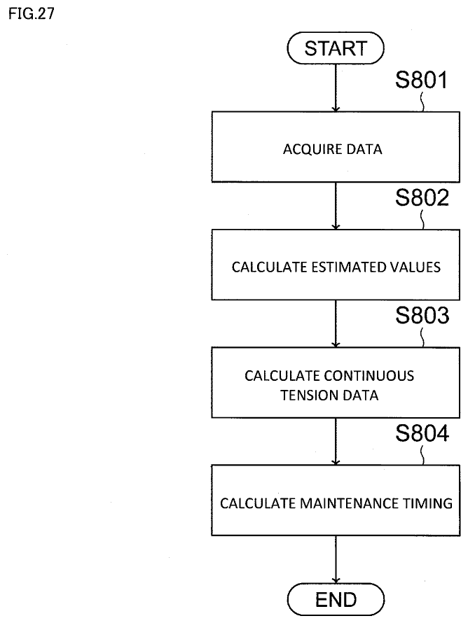

FIG. 27 is a flow chart for illustrating maintenance timing calculation processing to be performed by the state monitoring device according to the eighth embodiment.

In the maintenance timing calculation processing, an estimated value is calculated based on a time-varying function, and a maintenance timing is calculated based on the continuous tension data calculated through use of the estimated value. The maintenance timing is a timing at which maintenance work is required.

The time-varying function is a function indicating a variation with time of the parameter to be estimated due to a travel of the car 12. The parameter to be estimated is at least one of the plurality of parameters. The time-varying function is, for example, obtained from a test evaluation result and stored in advance in the monitoring device main body 20. The estimated value is a future value of the parameter to be estimated.

The parameter to be estimated in the eighth embodiment is the groove wear amount. The time-varying function in the eighth embodiment is a groove wear function. The groove wear function is a function indicating a relationship between a travel distance of the car 12 and the groove wear amount of each groove. The estimated value is a future value of the groove wear amount.

In Step S801, the monitoring device main body 20 acquires the discrete tension data and the data regarding the groove wear amount. In the eighth embodiment, the plurality of types of data regarding the rope specifications are incorporated into the tension model as fixed values.

Subsequently, in Step S802, the monitoring device main body 20 calculates a plurality of estimated values corresponding to different travel distances. Then, in Step S803, the monitoring device main body 20 calculates a plurality of pieces of continuous tension data respectively corresponding to the plurality of estimated values.

After that, in Step S804, the monitoring device main body 20 calculates the maintenance timing. Specifically, the monitoring device main body 20 obtains the maximum tension from the respective pieces of continuous tension data, and selects a travel distance at which the maximum tension exceeds the maximum allowable value. Then, a distance obtained by subtracting a set distance from the selected travel distance or a distance obtained by multiplying the selected travel distance by a safety factor is set as the maintenance timing. The safety factor is a positive value smaller than 1.

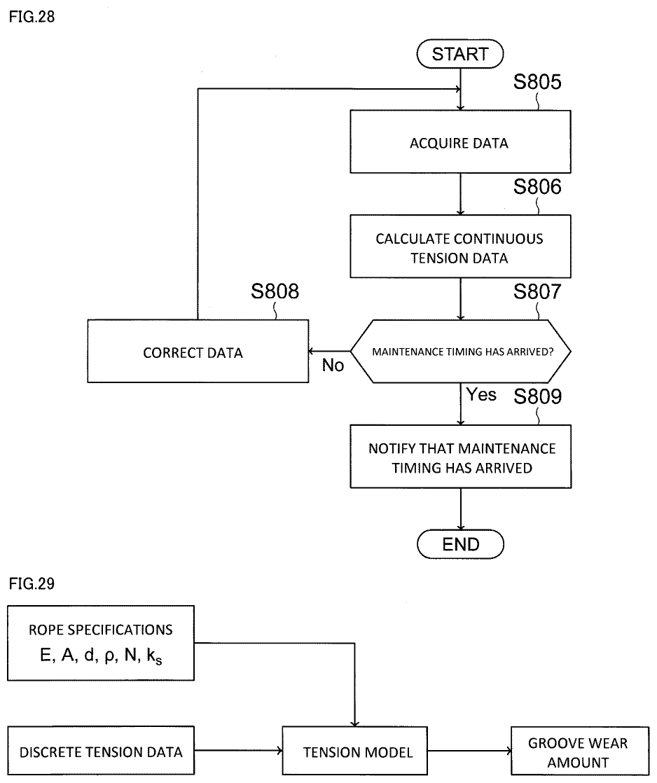

FIG. 28 is a flow chart for illustrating maintenance timing monitoring processing to be performed by the state monitoring device according to the eighth embodiment.

The maintenance timing monitoring processing is processing for monitoring whether or not the maintenance timing has arrived based on a cumulative travel distance of the car 12.

The cumulative travel distance of the car 12 can be calculated from the number of times of starting the car and the number of days that the elevator is in operation. The number of times of starting the car is the number of times that the elevator serves passengers in one day, and is, for example, the average number of starting times over a certain period based on the number of times estimated in advance when the elevator is delivered, actual operation data, or the like. The cumulative travel distance of the car 12 can also be acquired by receiving information regarding an actual travel distance from the elevator control panel.

In Step S805, the monitoring device main body 20 acquires data required for calculating the continuous tension data and data regarding the cumulative travel distance of the car 12. Then, in Step S806, the monitoring device main body 20 calculates the continuous tension data.

Subsequently, in Step S807, the monitoring device main body 20 determines whether or not the maintenance timing calculated in the maintenance timing calculation processing has arrived.

When the maintenance timing has not arrived, in Step S808, the monitoring device main body 20 corrects the data of a correctable parameter. This improves accuracy of the continuous tension data for a future cumulative travel distance.

When the maintenance timing has arrived, in Step S809, the monitoring device main body 20 notifies the control room that the maintenance timing has arrived.

A state monitoring method according to the eighth embodiment includes the same tension calculation step as that of the first embodiment, a maintenance timing calculation step, and a maintenance timing monitoring step. The maintenance timing calculation step is a step of calculating an estimated value of the future groove wear amount based on the groove wear function, and calculating the maintenance timing based on the continuous tension data calculated through use of the estimated value. The maintenance timing monitoring step is a step of monitoring whether or not the maintenance timing has arrived based on the cumulative travel distance of the car 12.

A state monitoring program according to the eighth embodiment is a program for causing a computer to execute the above-mentioned state monitoring method.

Further, a recording medium according to the eighth embodiment is a computer-readable recording medium having recorded thereon the state monitoring program for an elevator for causing a computer to execute the above-mentioned state monitoring method. The state monitoring program is stored in a readable format in a storage medium (for example, memory 202 of FIG. 33) serving as a recording medium. Then, processing described in the state monitoring program read from the storage medium is executed by the computer.

In the state monitoring method, the state monitoring program, the recording medium, and the state monitoring device described above, it is possible to estimate in advance the timing at which the maintenance work is required, and hence a maintenance plan can be efficiently set, thereby achieving an appropriate load on the maintenance person.

Further, it is monitored whether or not the maintenance timing has arrived, and hence the maintenance work can be carried out more reliably, and the elevator can be kept in a more appropriate state.

Next, a modification example of the eighth embodiment is described. A basic configuration of a state monitoring device according to the modification example of the eighth embodiment is the same as that of FIG. 14.

FIG. 29 is an explanatory diagram for illustrating a relationship between a tension model and input/output data in the modification example of the eighth embodiment. The plurality of types of data regarding the rope specifications include the Young's modulus E, the cross-sectional area A, the rope diameter “d”, the linear density ρ, the number of ropes N, and the shackle rigidity ks. In the modification example of the eighth embodiment, the plurality of types of data regarding the rope specifications and the discrete tension data are substituted into the tension model to calculate each groove wear amount. The relationship between the tension model and the input/output data in the modification example of the eighth embodiment differs from the relationship between the tension model and the input/output data in the eighth embodiment in that the groove wear amount is calculated.

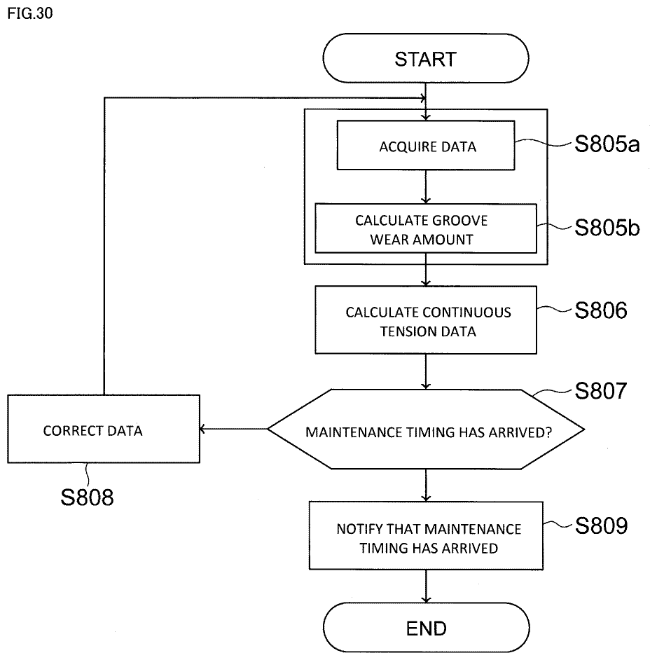

FIG. 30 is a flow chart for illustrating maintenance timing monitoring processing to be performed in the modification example of the eighth embodiment. The maintenance timing monitoring processing is processing for calculating, based on the cumulative travel distance of the car 12, the groove wear amount and the continuous tension data that correspond to the travel distance, and monitoring whether or not the maintenance timing has arrived.

In Step S805a, the monitoring device main body 20 acquires the data required for calculating the continuous tension data and the data regarding the cumulative travel distance of the car 12. Then, in Step S805b, the monitoring device main body 20 calculates the groove wear amount corresponding to the cumulative travel distance of the car 12 by the processing of FIG. 29. Then, in Step S806, the continuous tension data is calculated through use of the groove wear amount that has been calculated and the data required for calculating the continuous tension data and the data regarding the cumulative travel distance of the car 12 that have been acquired in Step S805a.

Subsequently, in Step S807, the monitoring device main body 20 determines whether or not the maintenance timing calculated in the maintenance timing calculation processing has arrived.

When the maintenance timing has not arrived, in Step S808, the monitoring device main body 20 corrects the data of a correctable parameter. This improves accuracy of the continuous tension data for a future cumulative travel distance.

When the maintenance timing has arrived, in Step S809, the monitoring device main body 20 notifies the control room that the maintenance timing has arrived.

A state monitoring method according to the modification example of the eighth embodiment includes the same tension calculation step as that of the first embodiment, the maintenance timing calculation step, and the maintenance timing monitoring step. The maintenance timing calculation step is a step of calculating an estimated value of the future groove wear amount based on the groove wear function, and calculating the maintenance timing based on the continuous tension data calculated through use of the estimated value. The maintenance timing monitoring step is a step of monitoring whether or not the maintenance timing has arrived based on the cumulative travel distance of the car 12.

A state monitoring program according to the modification example of the eighth embodiment is a program for causing a computer to execute the above-mentioned state monitoring method.

Further, a recording medium according to the modification example of the eighth embodiment is a computer-readable recording medium having recorded thereon the state monitoring program for an elevator for causing a computer to execute the above-mentioned state monitoring method. The state monitoring program is stored in a readable format in a storage medium (for example, memory 202 of FIG. 33) serving as a recording medium. Then, processing described in the state monitoring program read from the storage medium is executed by the computer.

According to the state monitoring method, the state monitoring program, the recording medium, and the state monitoring device according to the modification example of the eighth embodiment, it is possible to obtain the same effects as those of the eighth embodiment described above.

Further, according to the modification example of the eighth embodiment, work of measuring the groove wear amount can be omitted, thereby enabling reduction in workload on the maintenance person.

### Ninth Embodiment

Next, a ninth embodiment of this disclosure is described. A basic configuration of a state monitoring device according to the ninth embodiment is the same as that of FIG. 14.

Further, the state monitoring device according to the ninth embodiment executes the same maintenance timing calculation processing as that of FIG. 27 and the same maintenance timing monitoring processing as that of FIG. 28. However, in the ninth embodiment, Step S803 of FIG. 27 is omitted.

The parameters to be estimated in the ninth embodiment are the Young's modulus E and the cross-sectional area A of each rope 11. The time-varying function in the ninth embodiment is a rope aging function. The rope aging function is a function indicating a relationship between the travel distance of the car 12 and the Young's modulus E and cross-sectional area A. The estimated values are a future value of the Young's modulus E and a future value of the cross-sectional area A of each rope 11.

In Step S801 of FIG. 27, the monitoring device main body 20 acquires the discrete tension data and the plurality of types of data regarding the rope specifications.

Subsequently, in Step S802, the monitoring device main body 20 calculates a plurality of estimated values corresponding to different travel distances.

After that, in Step S804, the monitoring device main body 20 calculates the maintenance timing. Specifically, the monitoring device main body 20 selects the travel distance at which one of the Young's modulus E or the cross-sectional area A falls out of the allowable value. Then, the distance obtained by subtracting the set distance from the selected travel distance or the distance obtained by multiplying the selected travel distance by the safety factor is set as the maintenance timing.

The maintenance timing monitoring processing is the same as that in the eighth embodiment.

A state monitoring method according to the ninth embodiment includes the same tension calculation step as that of the first embodiment, the maintenance timing calculation step, and the maintenance timing monitoring step. The maintenance timing calculation step is a step of calculating the estimated values of the future value of the Young's modulus E and the future value of the cross-sectional area A based on the rope aging function, and calculating the maintenance timing based on the estimated values. The maintenance timing monitoring step is a step of monitoring whether or not the maintenance timing has arrived based on the cumulative travel distance of the car.

A state monitoring program according to the ninth embodiment is a program for causing a computer to execute the above-mentioned state monitoring method.

Further, a recording medium according to the ninth embodiment is a computer-readable recording medium having recorded thereon the state monitoring program for an elevator for causing a computer to execute the above-mentioned state monitoring method. The state monitoring program is stored in a readable format in a storage medium (for example, memory 202 of FIG. 33) serving as a recording medium. Then, processing described in the state monitoring program read from the storage medium is executed by the computer.

In the state monitoring method, the state monitoring program, the recording medium, and the state monitoring device described above, it is possible to estimate in advance the timing at which the maintenance work is required, and hence a maintenance plan can be efficiently set, thereby optimizing a load on the maintenance person.

Further, it is monitored whether or not the maintenance timing has arrived, and hence the maintenance work can be carried out more reliably, and the elevator can be kept in a more appropriate state.

In the eighth and ninth embodiments, function update processing of updating the time-varying function may be executed. Specifically, in the function update processing, the set distance is set in advance, and the estimated value at a time of reaching the set distance is calculated in advance through use of the time-varying function. Then, when the cumulative travel distance of the car 12 reaches the set distance, a difference between a current measured value or estimated value of the parameter to be estimated and the estimated value calculated in advance is calculated. The time-varying function is updated so that this difference becomes smaller.

Further, the updated time-varying function may be uploaded to the server. The server stores a plurality of groove wear functions collected from a large number of elevators for each elevator type, and the time-varying function is optimized from this data. The optimized time-varying function is transferred from the server to each elevator, and the groove wear function is updated to the most recent state in each elevator.

In this manner, through continuous updating of the time-varying function, accuracy of the time-varying function can be improved, and accuracy of the estimated value can be improved. This enables a more appropriate maintenance timing to be set.

### Tenth Embodiment

Next, a tenth embodiment of this disclosure is described. A basic configuration of a state monitoring device according to the tenth embodiment is the same as that of FIG. 14. Further, the state monitoring device according to the tenth embodiment is a server.

The monitoring device main body 20 has a machining amount of each groove stored therein as a parameter. An initial value of the machining amount is 0.

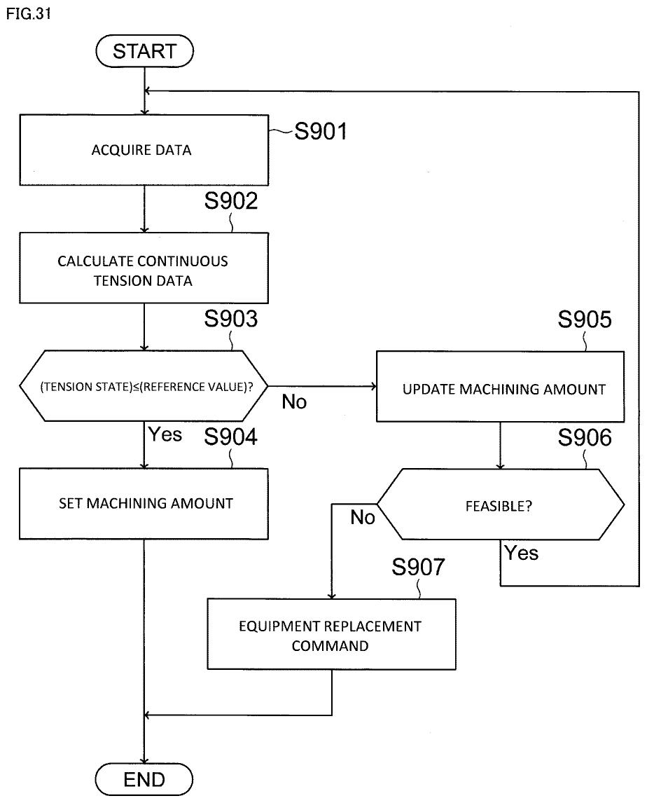

FIG. 31 is a flow chart for illustrating a part of an operation of the state monitoring device according to the tenth embodiment. In Step S901, the monitoring device main body 20 acquires the discrete tension data, the plurality of types of data regarding the rope specifications, the data regarding the groove wear amount, and the like through the communication network line. Some of the plurality of types of data regarding the rope specifications, for example, the rope diameter “d”, may be fixed values.

Subsequently, in Step S902, the monitoring device main body 20 calculates the continuous tension data.

After that, in Step S903, the monitoring device main body 20 determines whether or not a tension state is equal to or smaller than a reference value. Specifically, the monitoring device main body 20 determines whether or not the maximum tension and the fluctuation amount of the tension are each equal to or smaller than a reference value set in advance.

When the tension state is equal to or smaller than the reference value, in Step S904, the monitoring device main body 20 sets the machining amount of the groove, transmits the set machining amount to the elevator, and ends the processing. The maintenance worker performs mechanical machining on each groove based on the transmitted machining amount. When the machining amount is 0, which is the initial value, machining is not required.

When the tension state exceeds the reference value, in Step S905, the monitoring device main body 20 increases the machining amount of each groove by a set amount, and updates the machining amount.

Then, in Step S906, the monitoring device main body 20 determines whether or not the machining based on the updated machining amount is feasible.

Specifically, the monitoring device main body 20 determines whether or not a work time required for the machining based on the updated machining amount is equal to or smaller than a set time, and when the work time is equal to or smaller than the set time, determines that the machining is feasible, while determining that the machining is unfeasible when the work time exceeds the set time.

The monitoring device main body 20 also determines whether or not a strength of the pulley 10 is equal to or larger than a set strength due to the machining based on the updated machining amount, and when the strength is equal to or larger than the set strength, determines that the machining is feasible, while determining that the machining is unfeasible when the strength is smaller than the set strength.

When the machining based on the updated machining amount is feasible, the monitoring device main body 20 returns the process to the processing step of Step S901. Then, in Step S902, the monitoring device main body 20 calculates the continuous tension data in consideration of the updated machining amount. The monitoring device main body 20 repeats the above-mentioned processing until the tension state becomes equal to or smaller than the reference value.

When the machining based on the updated machining amount is unfeasible, it is difficult to make the tension state equal to or smaller than the reference value even when the machining amount is increased, and hence the monitoring device main body 20 transmits an equipment replacement command to the elevator in Step S907, and ends the processing.

A state monitoring method according to the tenth embodiment includes the same tension calculation step as that of the first embodiment, a mechanical machining determination step, and a machining amount setting step. The mechanical machining determination step is a step of determining whether or not mechanical machining is required to be performed on each groove based on the continuous tension data. The machining amount setting step is a step of setting the machining amount when it is determined that the mechanical machining is required to be performed.

A state monitoring program according to the tenth embodiment is a program for causing a computer to execute the above-mentioned state monitoring method.

Further, a recording medium according to the tenth embodiment is a computer-readable recording medium having recorded thereon the state monitoring program for an elevator for causing a computer to execute the above-mentioned state monitoring method. The state monitoring program is stored in a readable format in a storage medium (for example, memory 202 of FIG. 33) serving as a recording medium. Then, processing described in the state monitoring program read from the storage medium is executed by the computer.

In the state monitoring method, the state monitoring program, the recording medium, and the state monitoring device described above, it is determined whether or not the mechanical machining is required for each groove, and when the mechanical machining is required, the machining amount is set. Therefore, efficiency of the maintenance work for the pulley 10 can be improved.

Further, in the machining amount setting step, it is determined whether or not the mechanical machining is feasible, and when the mechanical machining is unfeasible, the equipment replacement command transmitted. Therefore, equipment replacement can be carried out at a more appropriate timing.

In the first to tenth embodiments, the plurality of parameters serving as the input data to the tension model may include data other than those described above, such as loading history data on the car 12, actual travel history data on the car 12, and data regarding a friction state. This can improve estimation accuracy.

The loading history data is data regarding a loading amount for each travel of the car 12. The travel history data is data regarding the travel distance for each travel of the car 12, and can be obtained from the number of revolutions of the pulley 10. The data regarding the friction state is data regarding a friction coefficient between the pulley 10 and the rope 11, and can be obtained from a function having, as a parameter, at least one of a viscosity of the lubricating oil, a temperature of a usage environment, a humidity of the usage environment, a contact pressure between the pulley 10 and the rope 11, or the like.

The time-varying function may also include a parameter such as the loading history data on the car 12, the actual travel history data on the car 12, or acceleration/deceleration history data on the car 12. Thus, through more accurate estimation of the continuous tension data, a degree of the aging of each component can be estimated more accurately. The acceleration/deceleration history data is data regarding positions at which the car 12 accelerated and decelerated for each travel of the car 12.

The aging function may also include, as a parameter, the number of times that the rope 11 has been bent at each site. Thus, the degree of the aging at each site of the rope 11 can be estimated more accurately.

Further, a method of acquiring the discrete tension data is not limited to the measurement performed by the tension measurement device 25. For example, a vibration period of the rope 11 acquired by an impact vibration method may be converted into a tension value.

Further, the rope in this disclosure is used in a broad sense, and also includes, for example, a belt for suspending the car.

Further, the elevator may be an elevator with a machine room, a machine room-less elevator, a double-deck elevator, an elevator of a one-shaft multi-car system, or the like. The one-shaft multi-car system is a system in which an upper car and a lower car arranged directly below the upper car are independently raised and lowered in a common hoistway.

Further, the second to tenth embodiments can be implemented in appropriate combinations.

As an example, a combination of the eighth embodiment and the ninth embodiment may be implemented. In this case, the monitoring device main body 20 calculates the continuous tension data through use of the future value of the Young's modulus E and future value of the cross-sectional area A of the rope 11 and the future value of the groove wear amount of the pulley 10. Therefore, the continuous tension data for the future cumulative travel distance can be calculated with higher accuracy, thereby improving accuracy of determining whether or not the maintenance timing has arrived.

Further, as another example, a combination of the sixth embodiment, the eighth embodiment, and the ninth embodiment may be implemented. In this case, the monitoring device main body 20 calculates continuous tension data through use of the future value of the Young's modulus E and future value of the cross-sectional area A of the rope 11 and the future value of the groove wear amount of the pulley 10. The monitoring device main body 20 also determines whether or not there is an abnormality in the aging data for the parameters that are subjected to an aging (future value of the Young's modulus E, future value of the cross-sectional area A, and future value of the groove wear amount). Thus, when the maintenance timing has arrived, it is possible to find out which of the parameters that are subjected to an aging has reached the aging allowable value, and hence it is possible to determine which of the rope 11 and the pulley 10 has deteriorated. Therefore, it is possible to determine a portion that has deteriorated at an early stage, and the efficiency of the maintenance work can be improved.

Further, as another example, a combination of the seventh embodiment and the tenth embodiment may be implemented. In this case, in the operation of the state monitoring device according to the tenth embodiment, when it is determined in Step S906 of FIG. 31 that the machining based on the updated machining amount is unfeasible due to the time required therefor exceeding the set time, the monitoring device main body 20 calculates the adjustment amount for the tension of each rope 11 by the processing described in the seventh embodiment so that the depths of the plurality of grooves becomes closer to a uniform value. The maintenance worker adjusts the tension of each rope 11 based on the received adjustment amount. In this manner, through the implementation of the combination the seventh embodiment and the tenth embodiment, even when the work time required for the machining of each groove cannot be secured, the groove depth of each groove can be adjusted so that the groove depth is brought to a desired state.

The combinations of the embodiments described above are merely examples, and other combinations may be implemented.

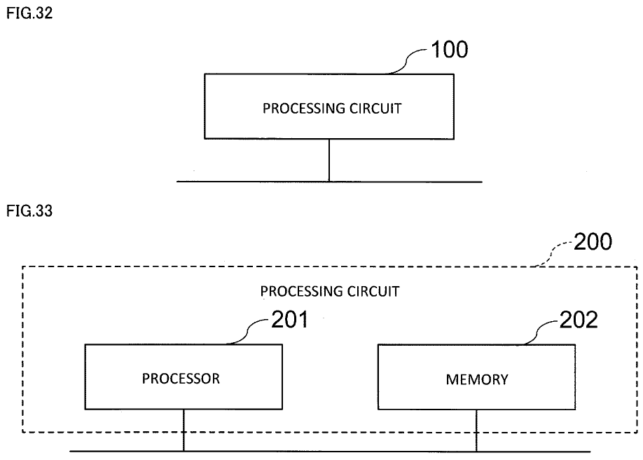

Further, each of the functions of the monitoring device main body 20 in the first to tenth embodiments is implemented by a processing circuit. FIG. 32 is a configuration diagram for illustrating a first example of the processing circuit for implementing each of the functions of the monitoring device main body 20 in each of the first to tenth embodiments. A processing circuit 100 of the first example is dedicated hardware.

Further, the processing circuit 100 corresponds to, for example, a single circuit, a complex circuit, a programmed processor, a processor for a parallel program, an application specific integrated circuit (ASIC), a field programmable gate array (FPGA), or a combination thereof. Further, the respective functions of the monitoring device main body 20 may be implemented by individual processing circuits 100, or the functions may be collectively implemented by the processing circuit 100.

Further, FIG. 33 is a configuration diagram for illustrating a second example of the processing circuit for implementing each of the functions of the monitoring device main body 20 in each of the first to tenth embodiments. A processing circuit 200 of the second example includes a processor 201 and a memory 202.

In the processing circuit 200, each of the functions of the monitoring device main body 20 is implemented by software, firmware, or a combination of software and firmware. The software and the firmware are described as programs to be stored in the memory 202. The processor 201 reads out and executes the programs stored in the memory 202, to thereby implement the respective functions.

The programs stored in the memory 202 can also be regarded as programs for causing a computer to execute the procedure or method of each of the above-mentioned units. In this case, the memory 202 corresponds to, for example, a nonvolatile or volatile semiconductor memory, such as a random access memory (RAM), a read only memory (ROM), a flash memory, an erasable programmable read only memory (EPROM), or an electronically erasable and programmable read only memory (EEPROM). Further, a magnetic disk, a flexible disk, an optical disc, a compact disc, a MiniDisc, a DVD, or the like may also correspond to the memory 202.

The function of each of the above-mentioned units described above may be implemented partially by dedicated hardware, and partially by software or firmware.

In this way, the processing circuit can implement the function of each of the above-mentioned units by hardware, software, firmware, or a combination thereof.

### REFERENCE SIGNS LIST

10 pulley, 11 rope, 12 car, 13 counterweight, 20 monitoring device main body

1. A state monitoring method for an elevator, comprising a tension calculation step of respectively modeling, as springs, a winding-side portion and a unwinding-side portion of each of a plurality of ropes with respect to a pulley having a plurality of grooves, and calculating a tension of the each of the plurality of ropes through use of a tension model formed of a plurality of equations of motion, the plurality of ropes being wrapped around the pulley and suspending a car and a counterweight,
wherein the tension model is configured to:
use discrete tension data and a plurality of parameters as input data, the discrete tension data including an actually measured value of the tension of the each of the plurality of ropes in a state in which the car is positioned at a measurement position in a hoistway; and
use continuous tension data as output data, the continuous tension data being continuous data on the tension of the each of the plurality of ropes which includes estimated values of the tension of the each of the plurality of ropes in states in which the car is positioned at positions other than the measurement position, and
wherein the tension model has a rope free length set as a displacement amount given to pulley-side end portions of each of the winding-side portions and each of the unwinding-side portions, the rope free length assuming a value obtained by subtracting, from a winding amount by the pulley, a rope extension amount within the winding amount.

2. The state monitoring method for an elevator according to claim 1, wherein the tension model is configured to use an actually measured value of a depth of each of the plurality of grooves as one of the plurality of parameters in the input data.

3. The state monitoring method for an elevator according to claim 1, wherein the rope extension amount assumes a value proportional to the rope free length and the tension of the winding-side portion.

4. The state monitoring method for an elevator according to claim 1, wherein the rope free length is a function of the winding amount and the tension of the winding-side portion.

5. The state monitoring method for an elevator according to claim 1, wherein a length of the winding-side portion and a length of the unwinding-side portion are calculated from the rope free length.

6. The state monitoring method for an elevator according to claim 1,
wherein the tension of the winding-side portion is calculated from a displacement difference between an upper end and a lower end of the winding-side portion, and
wherein the tension of the unwinding-side portion is calculated from a displacement difference between an upper end and a lower end of the unwinding-side portion.

7. The state monitoring method for an elevator according to claim 1,
wherein a rope rigidity of the winding-side portion is a function of a Young's modulus of the each of the plurality of ropes, a cross-sectional area of the each of the plurality of ropes, and a length of the winding-side portion, and
wherein a rope rigidity of the unwinding-side portion is a function of the Young's modulus of the each of the plurality of ropes, the cross-sectional area of the each of the plurality of ropes, and a length of the unwinding-side portion.

8. The state monitoring method for an elevator according to claim 1, further comprising a parameter value updating step of updating, when a difference between the continuous tension data and the discrete tension data is equal to or larger than a difference threshold value, at least one of the plurality of parameters so that the continuous tension data and the discrete tension data match each other.

9. The state monitoring method for an elevator according to claim 1, further comprising an adjustment amount transmission step of transmitting, based on at least the plurality of parameters or the continuous tension data, an adjustment amount for the tension that has been calculated or an adjustment amount for the tension that has been set in advance.

10. The state monitoring method for an elevator according to claim 9, wherein the adjustment amount transmission step includes determining, before the adjustment amount is transmitted, whether adjustment using the adjustment amount is feasible, and when the adjustment is determined to be unfeasible, issuing a notification that the adjustment is impossible.

11. The state monitoring method for an elevator according to claim 1, further comprising a maintenance command issuing step of determining, based on the continuous tension data, whether the tension of the each of the plurality of ropes falls out of a tension allowable value, and when the tension falls out of the tension allowable value, issuing a notification that maintenance work is required.

12. The state monitoring method for an elevator according to claim 1, further comprising an aging monitoring step of determining whether at least one parameter among the plurality of parameters falls out of an aging allowable value, and when the at least one parameter falls out of the aging allowable value, issuing a notification that maintenance work is required.

13. The state monitoring method for an elevator according to claim 1, further comprising a maintenance timing calculation step of calculating, based on a time-varying function indicating a variation with time of a parameter to be estimated which is at least one of the plurality of parameters due to a travel of the car, an estimated value which is a future value of the parameter to be estimated, and calculating, based on the continuous tension data calculated through use of the estimated value, a maintenance timing which is a timing at which maintenance work is required.

14. The state monitoring method for an elevator according to claim 13, further comprising a maintenance timing monitoring step of monitoring whether the maintenance timing has arrived based on a cumulative travel distance of the car.

15. The state monitoring method for an elevator according to claim 1, further comprising:
a mechanical machining determination step of determining whether mechanical machining is required to be performed on each of the plurality of grooves based on the continuous tension data; and
a machining amount setting step of setting a machining amount when it is determined that the mechanical machining is required to be performed.

16. The state monitoring method for an elevator according to claim 15, wherein the machining amount setting step includes determining whether the mechanical machining is feasible, and when the mechanical machining is unfeasible, transmitting an equipment replacement command.

17. A state monitoring program for an elevator, for causing a computer to execute the state monitoring method of claim 1.

18. A recording medium having recorded thereon a state monitoring program for an elevator for causing a computer to execute the state monitoring method of claim 1.

19. A state monitoring device for an elevator, comprising a monitoring device main body configured to respectively model, as springs, a winding-side portion and a unwinding-side portion of each of a plurality of ropes with respect to a pulley having a plurality of grooves, and calculate a tension of the each of the plurality of ropes through use of a tension model formed of a plurality of equations of motion, the plurality of ropes being wrapped around the pulley and suspending a car and a counterweight,
wherein the tension model is configured to:
use discrete tension data and a plurality of parameters as input data, the discrete tension data including an actually measured value of the tension of the each of the plurality of ropes in a state in which the car is positioned at a measurement position in a hoistway; and
use continuous tension data as output data, the continuous tension data being continuous data on the tension of the each of the plurality of ropes which includes estimated values of the tension of the each of the plurality of ropes in states in which the car is positioned at positions other than the measurement position, and
wherein the tension model has a rope free length set as a displacement amount given to pulley-side end portions of each of the winding-side portions and each of the unwinding-side portions, the rope free length assuming a value obtained by subtracting, from a winding amount by the pulley, a rope extension amount within the winding amount.
